(19) United States
(12) Patent Application Publication
(10) Pub. No.: US 2018/0114269 A1
(43) Pub. Date: Apr. 26, 2018

(54) ACCELERATED STREAMING PRICE CHART DATA FOR TRADING COMPETITIONS

(71) Applicant: Trade Off, LLC, Greenwood Village, CO (US)

(72) Inventors: Robert Kuck, Evergreen, CO (US); Mark Helweg, Houston, TX (US); Hubert Senters, Versailles, KY (US); James Du Plooy, Highlands Ranch, CO (US)

(21) Appl. No.: 15/791,334

(22) Filed: Oct. 23, 2017

Related U.S. Application Data
(60) Provisional application No. 62/412,251, filed on Oct. 24, 2016.
(60) Provisional application No. 62/546,977, filed on Aug. 17, 2017.

(51) Int. Cl. G06Q 40/04; G07F 17/32; A63F 13/25; A63F 13/50

(52) U.S. Cl. CPC G06Q 40/04; A63F 13/50; A63F 13/25; G07F 17/3295

(57) ABSTRACT

A simulated real-time trading engine includes to a network of computer processors, storage devices, network and internet hardware, and front-end technology for displaying accelerated data streams of historical price data for multi-user trading competitions. The invention allows for accelerated streaming rates of price history wherein several days' worth of historical price data can be streamed within several minutes, which enables the creation of significantly shorter trading competitions. Trading competition results are displayed electronically on charts which can be viewed on personal computers and smart devices.

### CROSS REFERENCE TO RELATED APPLICATIONS

This application claims priority to U.S. Provisional Application No. 62/412,251, filed on Oct. 24, 2016, by Robert Kuck, et al., and entitled “ACCELERATED STREAMING PRICE CHART DATA FOR TRADING COMPETITIONS” and further claims priority to U.S. Provisional Application No. 62/546,977, filed on Aug. 17, 2017, by Mark Helweg, and entitled “RANDOMIZATION AND OBSCURING OF INFORMATION”, the disclosures of which are incorporated herein by reference as though set forth in full.

### FIELD OF THE INVENTION

Various embodiments and methods of the invention relate generally to financial data processing and analysis and internet gaming competitions. More specifically, the embodiments of the invention relate to an internet or a computer-implemented system for producing accelerated streaming price data for online trading competitions, where traders make buy and sell decisions and compete with other traders for cash prizes using historical market data that is broadcasted at an accelerated rate, wherein traders can trade several days' worth of data within several minutes.

### BRIEF DESCRIPTION OF THE DRAWING

FIG. 1 shows an exemplary application of a speed trading system 100, in accordance with an embodiment of the invention.

FIG. 2 shows further details of the simulated real-time trading engine 106 of FIG. 1, in accordance with an embodiment of the invention.

FIG. 3 shows the speed trading system 100 deployed in a cloud in accordance with an exemplary application of an embodiment and method of the invention

FIG. 4 shows a flow chart outlining steps by the speed trading system 100 in performing user registration, in accordance with a method of the invention.

FIG. 5 shows a flow chart of steps performed in performing competition for cash prize.

FIG. 6 shows a flow chart of steps performed in a “Request” competition flow, in the speed trading system.

FIG. 7 shows exemplary speed trading competitions displayed in an “Events” tab for the benefit of a trader. At this point, traders can sign up to compete in competitions.

FIG. 8 shows a graph of the status of an exemplary speed trading competition before the competition begins. Traders can add technical analysis tools, of their choice, to this graph, which can alternatively be a chart. The competition countdown clock is displayed at the bottom of the chart.

FIG. 9 shows an exemplary speed trading competition chart during a live competition.

FIG. 10 shows an exemplary speed trading competition chart during a live competition. Notice the progress bar positioned at the bottom of the chart window to communicate the progress of the competition through to completion of the competition.

FIG. 11 shows an exemplary speed trading competition chart during a live competition. Notice “buy” and “sell” arrow markers above the “price” bars where a trader has generated “buy” and “sell” orders during the speed trading competition.

FIG. 12 shows an exemplary speed trading competition chart after a competition has concluded. Traders have the option to leave feedback and rate the competition.

FIG. 13 shows an exemplary speed trading competition results page after a live competition has concluded. Traders have the option of viewing their rank against other traders' ranks and view their performance using equity curves during the speed trading competitions.

FIG. 14 shows an exemplary merchant services screen displaying money added money to a trader's account for cash prize competitions.

FIG. 15 shows a trading system, in accordance with an implementation of the disclosure.

FIGS. 16 and 17 each show further details of the system 1000 of FIG. 15, in accordance with various implementations of the invention.

FIG. 18 shows further details of the historical data server 1200 (also referenced as “200” in FIG. 18), in accordance with implementations of the disclosure.

FIG. 19 shows a block diagram of further details of the randomizer, in accordance with various implementations of the disclosure.

FIG. 20 shows a block diagram with further details of the modifier, in accordance with various implementations of the disclosure.

FIG. 21 shows a block diagram of further details of the shifter 1260, in accordance with various implementations of the disclosure.

FIG. 22 shows a block diagram of further details of the splicer, in accordance with various implementations of the disclosure.

FIG. 23 shows further details of the changer 1430, in accordance with exemplary implementations of the invention.

FIG. 24 shows an exemplary competition, in accordance with an implementation of the invention.

FIG. 25 shows a system 8000 employing an implementation of the disclosure. The client devices 1020 may be in the form of a desktop computer, an iPad, and/or smartphone.

FIG. 26 shows further details of the historical data server 1200, in accordance with one of the implementations of the disclosure.

FIGS. 27-29 show details of various implementations of the client devices 1020.

### SUMMARY OF THE INVENTION

An embodiment of the invention includes a speed trading competition system and method for speed trading competitions and has the ability to offer online traders new types of trading competitions where traders can test their skills against other traders in both free competitions and paid competitions for cash prices (or prizes of monetary/non-monetary value).

### DETAILED DESCRIPTION OF VARIOUS EMBODIMENTS

Speed trading technology of various embodiments and methods of the invention address one of the major limiting factors of trading competitions—the significant real-time required to finish the trading competition. Currently, most real-time trading competitions require several days at a minimum or, more commonly, one or more months. The reason for this is that existing trading competitions utilize real-time streaming price data for trading competitions, which streams at the same pace that trading activity occurs in the markets being traded.

An additional challenge for real-time trading competitions is that markets can be extremely quiet and inactive for extended periods of time, which can include several days to several weeks of time periods. When markets are inactive or quiet, trading competitions are boring and tend to lose the interest of the participants. Because no one can predict the future of any market, real-time trading competitions tend to last longer in order to negate the risk of “dead periods” with inactive or quiet price action in the markets.

Most people do not have the time available or capacity to participate in prolonged trading competitions that last for several days to several months due to the requirements of life, which include work and family responsibilities. Traders who wish to compete for cash prizes only have the option of entering long and drawn-out real-time trading competitions. Most traders typically opted not to participate in these types of trading competitions because of the undesirable characteristics of these events discussed above.

Because time is extremely valuable to most people, most people tend to enter trading competitions that do not require a great deal of time. In fact, studies show that most people prefer to participate in competitions that take anywhere from a few minutes to a few hours instead of competitions that require several days to several months.

Embodiments and methods of the invention stream historical market data at an accelerated rate. They have the ability to stream several days' worth of price data within in several minutes by broadcasting historical price data at a much faster rate than it traded in real-time. The result is that traders can compete against other traders in online trading events that last for time periods of less than 5 minutes. The ability to compress the time-series data from actual market price (bar) history for online trading competitions is revolutionary in the online trading industry.

An embodiment of the invention utilizes the power of cloud technology or online servers to store and stream market history from time-series servers directly to web browsers on personal computers or web browsers or applications on smart devices. Cloud-based servers are designed to store historical market data with the ability to update existing data history after each daily trading session has been completed. Online storage devices can store massive amounts of historical market data with ease. An embodiment and method of the invention employs cloud servers and storage devices to access market data history and then stream any defined market data history period directly to charts displayed on computer browsers or on computer applications.

Further, an embodiment and method of the invention has the ability to define how quickly historical market data is streamed. When this is done, a streaming data broadcast rate is defined in price bars (per second) for a speed trading competition. This gives flexibility to every speed trading competition as to how fast historical price data is streamed to traders on their devices. From a practical standpoint, various embodiments and methods of the invention has the flexibility to stream historical data at a rate that allows most traders to make effective buy and sell decisions based on what they are seeing on their price charts. Additionally, in some embodiments and methods of the invention, each trader, in real time, may request a desired trading time, and various methods and embodiments of the invention may be optionally employed to accommodate the traders in this respect, as set forth herein. For example, an exemplary method is to use an average trading time of the participating traders' who have requested a trading time. The final trading time, as averaged, would be calculated over a period of time and the actual trading time would be adjusted according to the calculated average time. Alternatively, the trading time may be adjusted in accordance with the slowest trading time or the fastest trading time. These are but a few of a host of alternatives for adjusting the trading time.

Once a speed trading event has been streamed to either a personal computer device or a smart device, the hardware and software technology of the respective device displays the historical price data on a price charting graphic user interface (GUI) for viewing by traders. A speed trading event, as referred to herein, is the entire trading competition and also referenced herein as the “competition” or “trading competition”. Traders can apply one or more chart analysis tools, such as examples provided herein, to their device chart GUI for the purpose of analyzing price action in order to predict the future price direction in a speed trading competition.

Because the goal of most speed trading competitions is typically to grow a simulated trading account as much as possible during the competition, as one example, in order to win cash prizes and win the trading competition, forecasting the next price move on the chart display is important for each trader to master in order to grow his or her simulated account. During speed trading competitions, traders can view their real-time competition ranking compared to other traders to see how they are performing or how they place at the conclusion of each competition.

A trader grows his or her simulated trading account value by executing profitable trades. Profitable traders, resulting from profitable trading decision(s), are made when a trader buys shares of a stock and prices move higher, and then the trader sells (exits) his or her shares of that same stock at higher prices, resulting in a profitable trade. The opposite principle can be applied to “short selling” trades. If a trader sells (shorts) shares of a stock and prices fall and then the trader buys the stock shares back at lower prices, this will also result in a profitable trade. The more profitable trades a trader generates, the more he or she grows his or her simulated trading account. Making losing trades will have the opposite effect on a simulated trading account by reducing the value of a simulated trading account.

Charts in exemplary speed trading competitions, in some embodiments of the invention, may largely reflect the technical market analysis tools used on trading platforms at brokerage houses, thereby emulating competition environments highly similar to real-time trading platforms at brokerage firms. This is also a major benefit as traders can compete in speed trading competitions which utilize a large range of market price data, such as several days' worth of market price data, but are able to compress this data to within a time period of several minutes. Trading data is compressed by reducing the time period between price ticks and by strategically removing price history, as needed, in order to stream price bar history at a faster rate than it originally streamed at. This is determined for each trading competition. The invention allows the designer of each event, including either humans or devices, to define the price compression characteristics for each speed trading event. The compression technique can be static or dynamic for a speed trading event, which can result in either static or variable (dynamic) price bar streaming rates.

Once each speed trading competition has concluded, the simulated trading accounts of each trader participant is compared to the other simulated trading accounts of the other traders in the competition in order to determine who grew their accounts the most during the competition, as one competition type example. Accounts in speed trading competitions are grown by entering “Buy” orders at lower prices and then entering offsetting “Sell” orders at higher prices in order to achieve profitable trades and grow the simulated account equity. This is an example of what is known as a “long positions” in trading. Traders can also initiate what is referred to as “short positions,” where they initiate “Sell” orders at higher prices and then offset the short positions by entering offsetting “Buy” orders at lower prices, which is the reverse of the “Long” Trade example.

Speed trading competitions, of the various embodiments and methods of the invention, can have many different competition types and payout structures. Payout structures can include either a single winner (Winner Takes All) or multiple winners who rank in the top ‘N’ percentage of simulated account balances at the conclusion of the competition, as two examples. Payout structures can also include fixed payout structures which pay out a percentage increase to the top N percentage of simulated account balances. An example of this would be paying the top 40% of traders 200% of their entry fees.

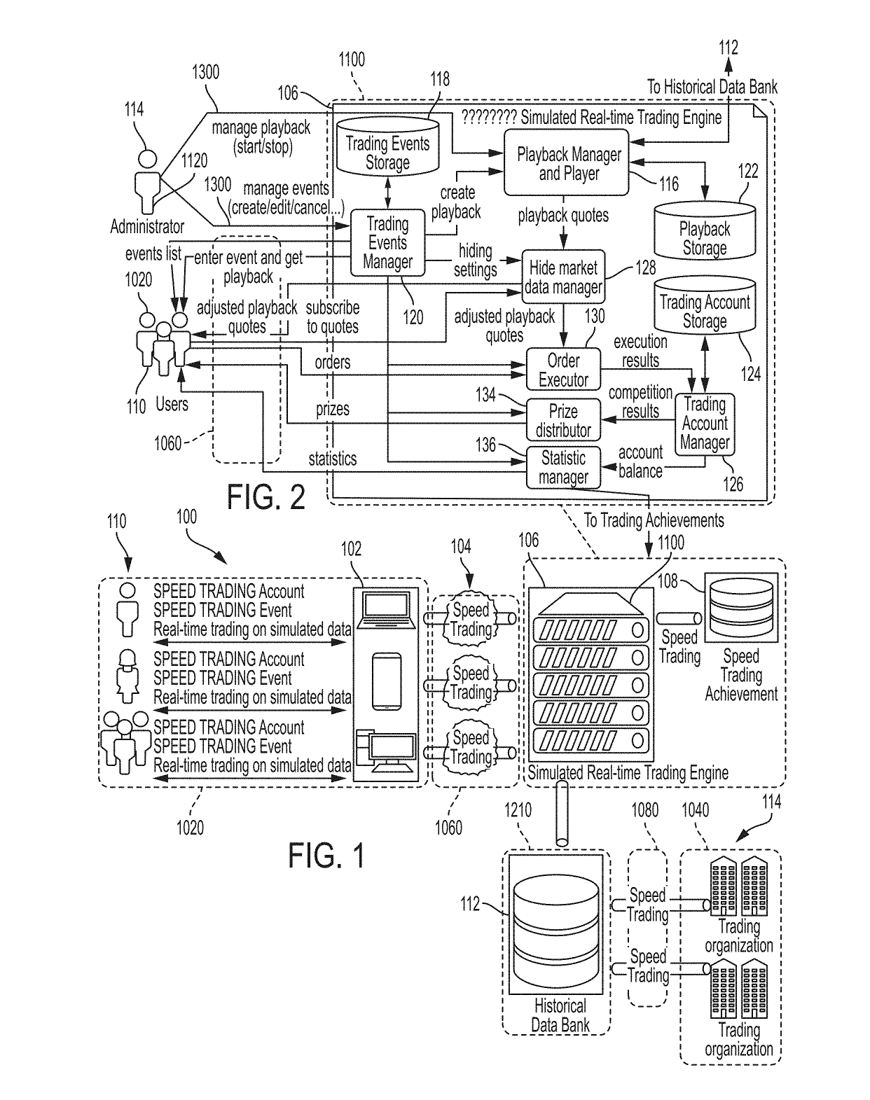

FIG. 1 shows an exemplary application of a speed trading system 100, in accordance with an embodiment of the invention. The speed trading system 100 is generally a system for simulation of real-time trading competitions and is shown to include users (or “traders”) 110 accessing computing devices 102 that are in communication with a simulated real-time trading engine 106 through the cloud 104 and the simulated real-time trading engine 106 is shown being in communication with a historical data bank 112 and a speed trading achievements 108. The historical data bank 112 is shown to be in communication with trading organizations 114, such as brokerage firms, trading exchanges or the market data vendor companies.

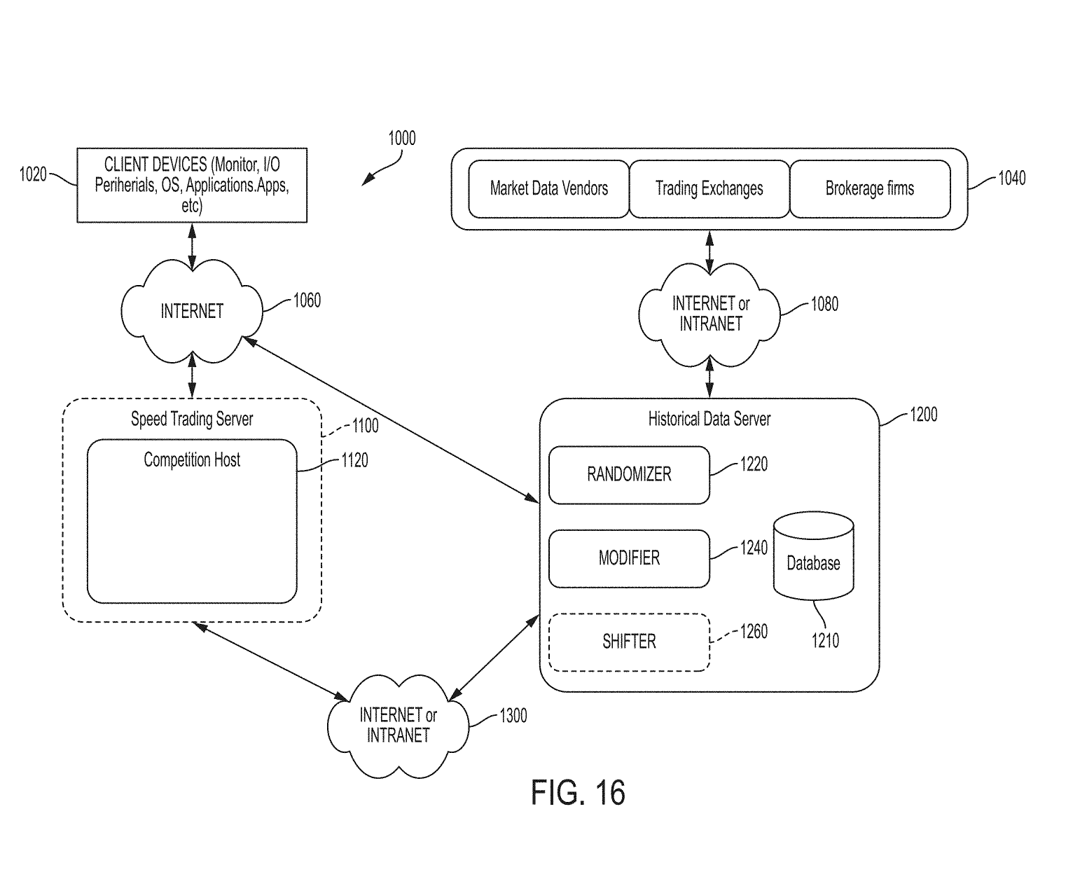

Some of the structures in FIG. 1 are referenced using pointers 1020-1210 and are described below relative to FIGS. 15-17.

The historical data bank 112 receives, either through the internet otherwise, historical information relevant to trading and stores the same for consumption by the simulated real-time trading engine 106, which is generally an engine that assists in the real-time simulation of a trading competitions based on actual historical trading data. Historical data refers to actual real-life trading data collected over a predetermined period of time, such as hours, days, . . . , The historical data is ultimately received by users at a fast speed, i.e. a number of changes to speed trading data per second.

The simulated real-time trading engine 106 accesses the historical data bank 112 and retrieves historical trading data and upon doing so is in a position to initiate a trade with the users 110 or a subset thereof. The users 110 can each communicate with the simulated real-time trading engine 106 through a distinct device among the computing devices 102 and access the simulated real-time trading engine 106 through a cloud-based platform. In the exemplary embodiment shown in FIG. 1, a user, shown in the shape of a man, has a laptop as his computing device, another user, in the shape of a woman uses a smart phone as her computing device and a group of users use a commonly employed device used by an enterprise, such as large computing systems, as their computing device.

Each of the users 110, sets up a trading account, through its computing device, with the simulated real-time trading engine 106 to allow it to participate in simulated trading competitions with other participating users, i.e. trading events. Thereafter, the user can trade, in real-time, on the simulated real-time trading engine 106. The outcome of the competition is saved by the simulated real-time trading engine 106 in the speed trading achievements system 108. The user in the system of FIG. 1 receives trading data, in real-time, from the simulated real-time trading engine 106. The trading data that the user receives from the simulated real-time trading engine 106 is not from real-time exchange trades and is rather simulated using historical trading data, as will be further discussed relative to figures to follow.

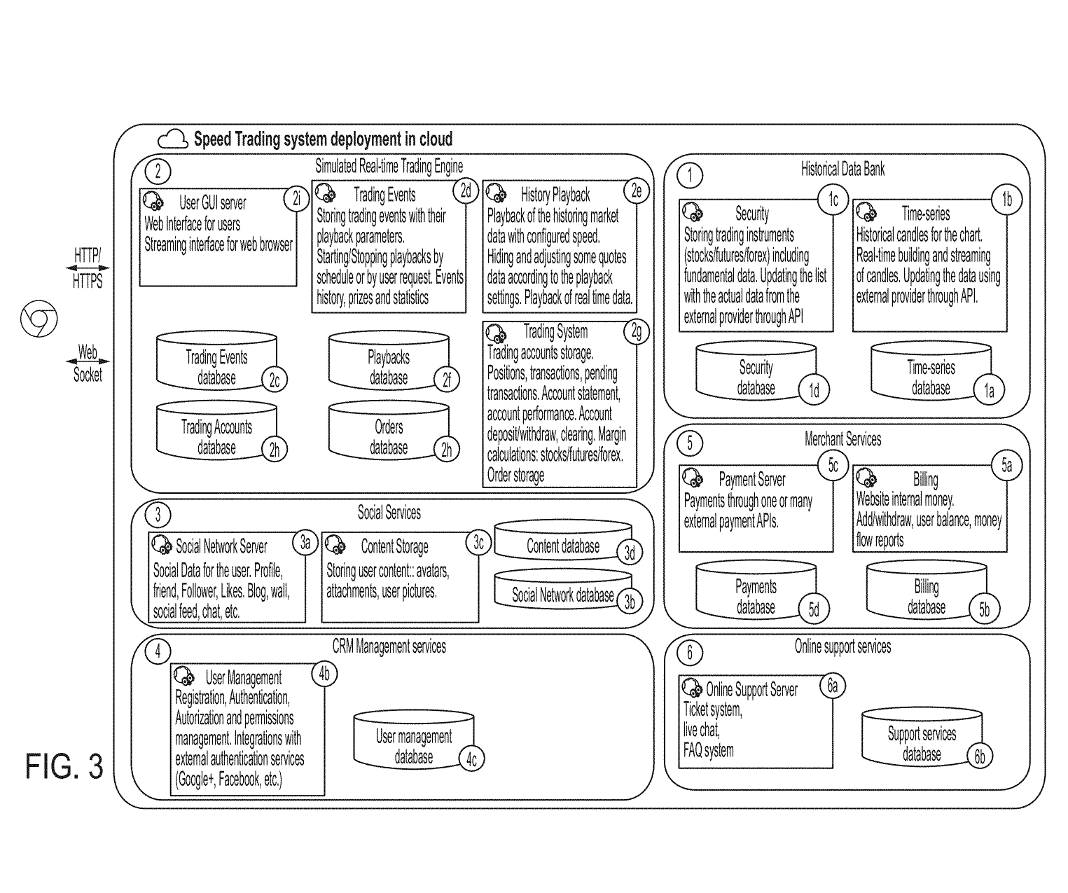

FIG. 2 shows further details of the simulated real-time trading engine 106 of FIG. 1, in accordance with an embodiment of the invention. In FIG. 2, the simulated real-time trading engine 106 is shown to be utilized by the users 110 and administrator 114 in the manner described above relative to FIG. 1, in accordance with an embodiment of the invention. The simulated real-time trading engine 106 is shown to include trading events storage 118, trading events manager 120, playback manager and player 116, hide market data manager 128, order executor 130, prize distributor 134, statistic manager 136, playback storage 122, trading account storage 124, and trading account manager 126.

The administrator 114 manages events by creating, editing or cancelling events by use of the trading events manager 120. The administrator 114, in FIG. 2, further manages playback (or start and stop of events) by using the playback manager and player 116. One of the users 110, in FIG. 2, is shown to receive an events list and go-ahead to enter an event and receives playback identification from the “trading events manager” 120. Another user among the users 110 is shown to subscribe to quotes and receive adjusted playback quotes through the hide market data manager 128 and yet another user among the users 110 places orders through the order executor 130 and receives prizes, potentially, from the prize distributor 134 in addition to trade statistics from the statistic manager 136.

The playback manager and player 116 receives playback, i.e. start/stop, from the administrator 114 and upon instruction from the trading events manager 120, creates playback. It provides playback quotes to the hide market data manager 128, which also receives hiding settings from the trading events manager 120. Hiding options are set by admin during the trading event creation process. According to that settings the real historical quotes are adjusted using a special algorithm. The purpose of the adjustment is to make user not able to identify the stock and the historical period being played. The hide market data manager 128 sends adjusted playback quotes, based on preferences. The order executor 130 receives information from the trading events manger 120 and orders from the users 110, which it executes and provides the execution results to the trading account manager 126.

After the trading event completes the prize distributor 134 receives prize information from the trading events manger 120, trading results from the trading account manager 126 and sends payouts to the winner users 110. Similarly, the statistic manager 136 receives competition information from the trading events manager 120 and trading account balances information from the trading account manager 126, processes them and sends statistics including the performance chart to the users 110.

The trading account manager 126 maintains trading account information for the users in the trading account storage 124 and retrieves this information when needed.

The playback manager and player 116 receives real-life trading data from the “historical data bank” shown in FIG. 1 and plays them with the configured speed.

It is noted that the blocks shown in the simulated real-time trading engine 106 of FIG. 2 may be implemented in software or hardware, dedicated or a computing device that upon execution of software or code carries out steps reflecting the function of a block. Similarly, the flow charts shown in the figures of the subject patent document may be implemented in software or by hardware, either dedicated or by a computing device that carries out its functions by execution of code or program.

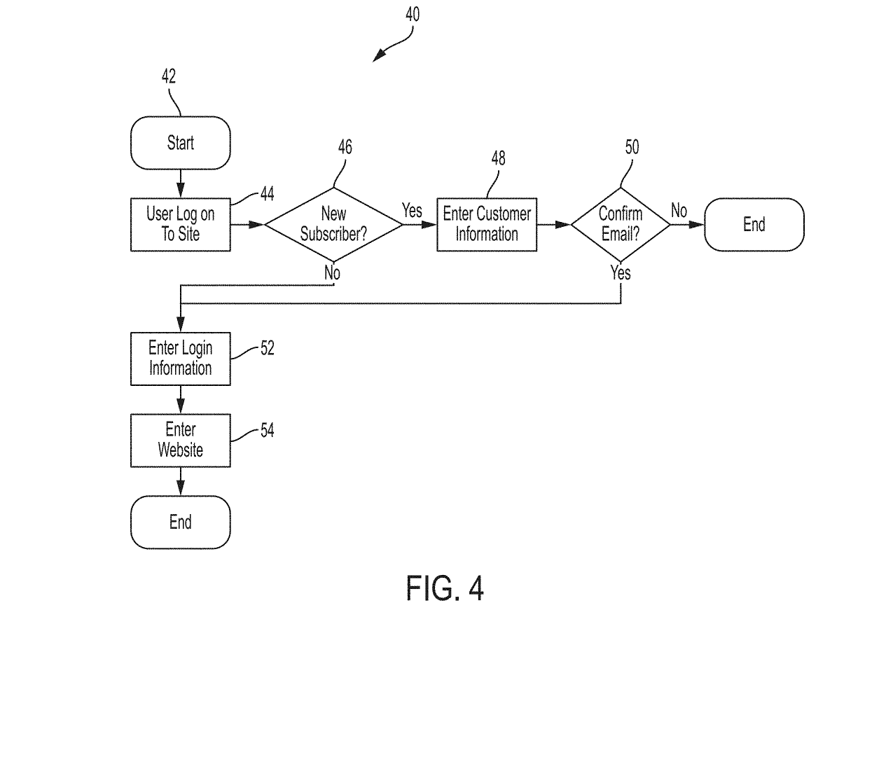

FIG. 3 shows the speed trading system deployed in a cloud.in accordance with an embodiment and method of the invention. In FIG. 3, a historical data bank 1 is shown to include a Time-series database storage device 1a and 1b, a Time-series server 1b, a Security server 1c, a Security database storage device 1d, a Connections to the trading organizations, and an Internal TCP/IP network.

A Speed Trading Management devices is shown to include a Connection to the Internet for user access through an Internal TCP/IP network. Also included is Trading Events database storage device, a Speed Trading Events server, a Prize distribution system, and a Statistics system.

A History Playback server, which is analogous to the trading events manager 120, and a Market Data Hiding system are shown. A Playback database storage device is further shown along with a Trading system server, a Trading Account Management system, an Order Management system, and an Order Execution system. Also, a Trading System storage devices is shown to include an Orders database storage device and a Trading Accounts database storage device. A User GUI server is also shown.

A Social Services devices is shown to include a Social Network Server, a Social Network database storage device, a Content Storage Server, a Content database storage device, and an Internal TCP/IP network. Further, a CRM Management devices includes a Connection to the Internet for user access, a User Management server, a User management database storage device, and an Internal TCP/IP network. A Merchant services devices is shown to include a Billing server, which includes a Financial reporting system, which is shown to include a Billing database storage device and Payments server including a Fraud detection system and a Payments reporting system, Payments database storage device, and an Internal TCP/IP network. Further, an online support services devices includes an Online support server with a Tickets system, a Live chat system, and a FAQ system, an Online support services database storage device, and an Internal TCP/IP network. The TCP/IP is a connection to a network or a network, commercially available, that is used to connect to the internet.

During operation of an embodiment of the invention, the administrator creates a speed trading event using the web interface supplied by the user GUI server 2i through the internet connection 2a. The speed trading events server 2d sends speed trading parameters to the history playback server 2e through the internal TCP/IP network connection 2b. Examples of speed trading parameters are bars per minute, ticks streamed per price bar, ticks streamed per second, price bar aggregation, stock symbol, start date and end date of data history. An example of price bar aggregation is 5-minute bars, 10-minute bars, and 60-minute bars. “Ticks” as referred to herein refer to stock trades. Bars per minute (also referred to herein as “bars/minute”) represents the speed of history playback.

The history playback server 2e requests data from the “time-series sever” 1b according to the above parameters. The “time-series server” 1b accesses the “time-series database” storage device 1a and retrieves the historical trading data. The “history playback server” 2e downloads the historical trading data in accordance with the speed trading parameters and applies data hiding to the market data. “Market data” as used to herein refers to information that is price and volume-related, such as without limitation, commonly known “open”, “high”, “low”, “close” and “volume. Users of the simulated real-time trading engine 2, through a web interface, join the speed trading event and are delivered the downloaded historical data with up to a predetermined number of changes to speed trading data per second. Through the internet connection, the downloaded historical data is displayed to the users (or “traders”) to allow analysis of the market data that the users utilize to place orders, in real-time, using the web interface until the speed trading event ends.

The speed trading events server 2d generates results of the speed trading event upon the end of the speed trading event. The billing server 5a receives the results of the speed trading event and processes enrollment of the user. Processing of enrollment of the users entails collecting entry fees for each user that signs up. If the minimum required users do not sign up for a trading competition, the competition could be cancelled. In an exemplary embodiment and method of the invention, payout is given to winners of the competition according to the price payout structure of the trading competition. Also, trader performance data in the speed trading event is collected.

The simulated real-time trading engine 2 uses actual historical trading data to emulate actual trading events by allowing users of the simulated real-time trading engine to utilize the historical trading data, in for example seconds, to trade with short trading times to avoid actual trading events with substantially longer trading times.

Historical data bank system 1 in an embodiment of the invention is responsible for market data collection and storage. It collects securities and price data into security database storage device 1d and time-series database storage device 1a. Data collection performed automatically by the integration modules of the security server 1c and time-series server 1b from the external sources provided by brokerage firms, trading exchanges or the market data vendor companies.

Real-time trading competitions are undesirable to many traders because they tend to last for far too long and they cannot guarantee active market conditions during any competition period. Real-time trading competitions are at the mercy of the markets. Speed trading competitions embodiments and methods of the invention, on the other hand, can be designed to last for only several minutes and, in addition, have the flexibility of only including active market price data history within trading competitions. These embodiments and methods are designed to meet the demands of todays' traders by both compressing trading competitions to shorter time intervals, such as minutes or hours, and by having the ability to include active historical price periods in the competition, what makes each speed trading competition much more exciting.

Real-time trading competitions allow traders to trade simulated competition accounts using real-time streaming data along with simulated currency funded trading accounts. In general, these real-time simulated trading accounts have proven to be ineffective in attracting traders to real-time events. Real-time simulated trading competitions are very slow and can last for weeks to months. Most traders do not have the time nor do they have the capacity to commit to this type of competition. In addition, real-time simulated trading competitions rely on real-time data which is at the mercy of the markets in terms of what types of market conditions they experience during the trading competition. Various embodiments and methods of the invention fix the shortfalls of real-time trading competitions by allowing traders to compete in speed trading competitions which can be designed to last for very short time periods and which can be designed to include more volatile, or more active, segments of historical price history.

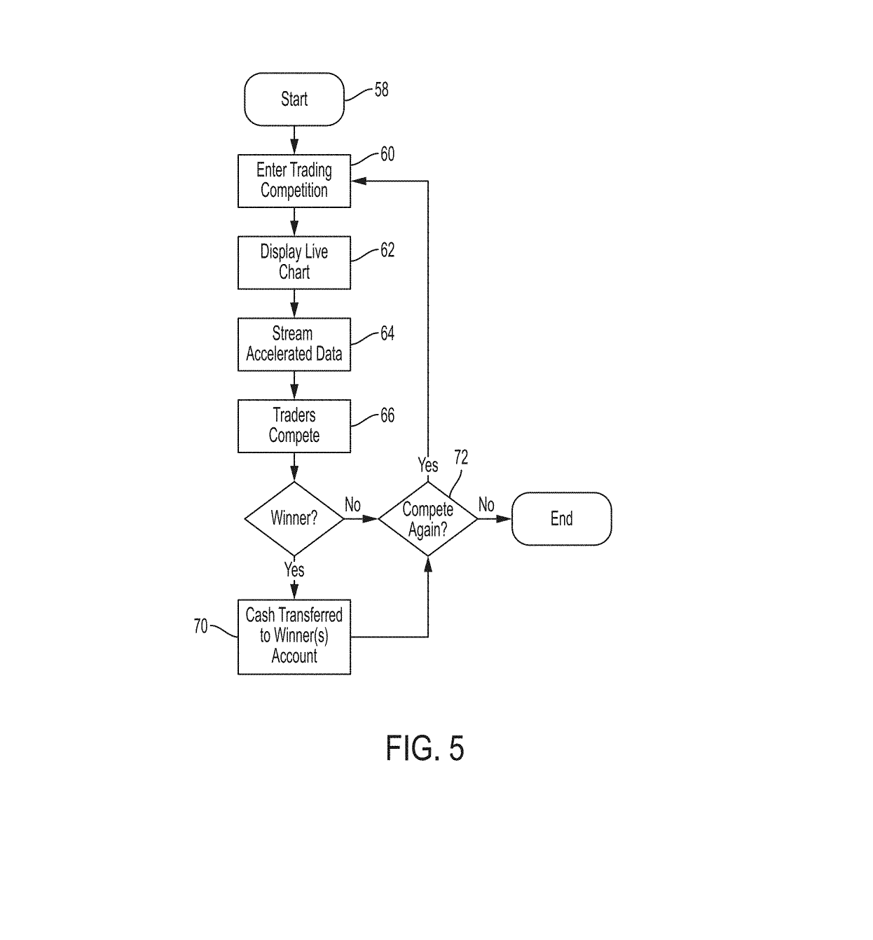

FIG. 4 shows a flow chart 40 outlining steps by the speed trading system 100 in performing user registration, in accordance with a method of the invention. At 42, the steps begin and at step 44, the user/player/competitor logs into the competition site or registers, as the case may be. Next, at 46, the user is identified as a new user, or not, and in the case of a new user, the process continues onto the step 48 and in the case where its not a new user, the process continues onto step 52 where the user is asked for his/her login information and allowed access to the website t step FIG. 54. At step 48, the user is asked to input identification information and perhaps a payment method and related information. Next at step 50, the user is verified by for example, the use of an email confirmation message, although other ways of identifying the user may be employed.

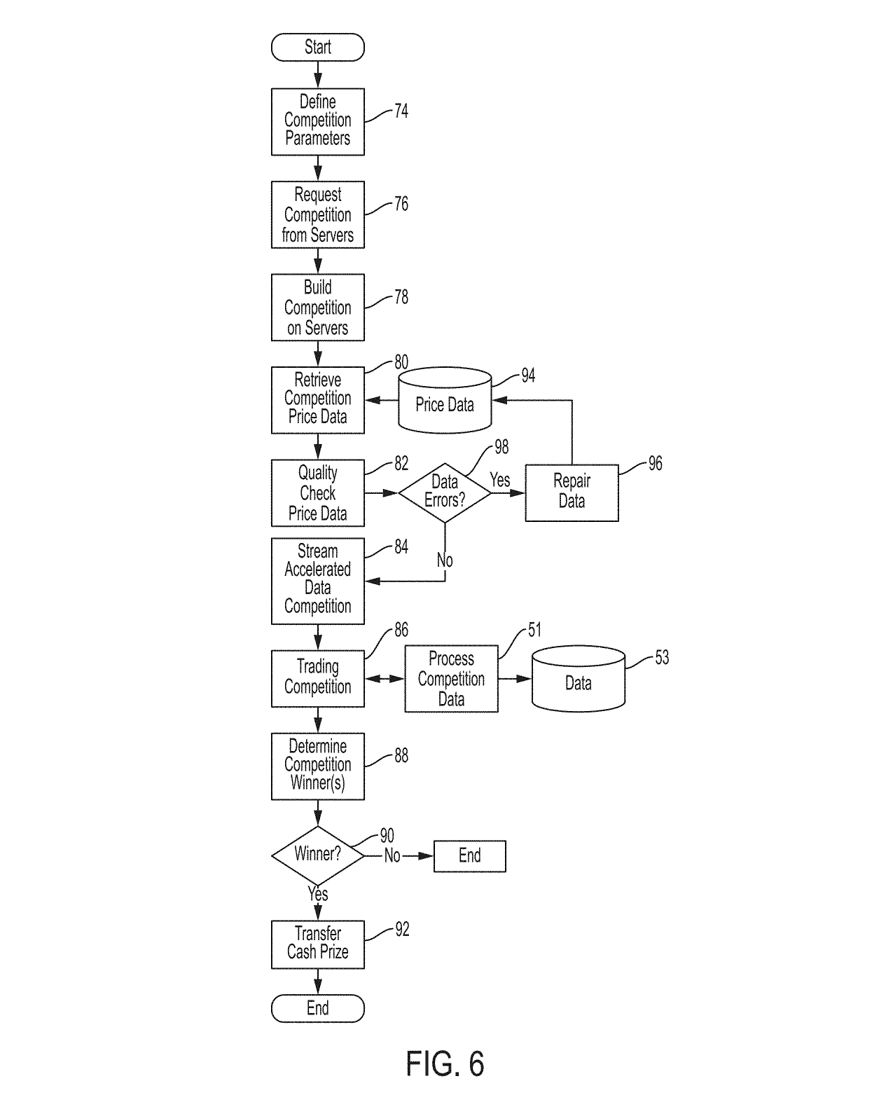

FIG. 5 shows a flow chart 58 of steps performed in performing competition for cash prize. At step 60, a competitor/player enters a trading competition, as discussed relative to FIG. 4. Next, at step 62, a chart of real-time play/competition, showing stocks being traded, for example, is displayed to the new player. Next, at step 64, data (for instance stock data) is streamed. This is accelerated data because it is from an actual historical trade but because it is historical, it can be accelerated. At step 66, assuming other competitors have logged in/registered to play, traders/competitors/players start to compete. At 68, a winner is declared upon a player winning the competition, and at 70, the prize, in this case cash or funds, are transferred to the winner's account or paid out through some other mechanism. If no winner is declared and/or after step 70, at 72, a determination is made as to whether the competition continues and if so, the process goes back to step 60 and if not, the process ends.

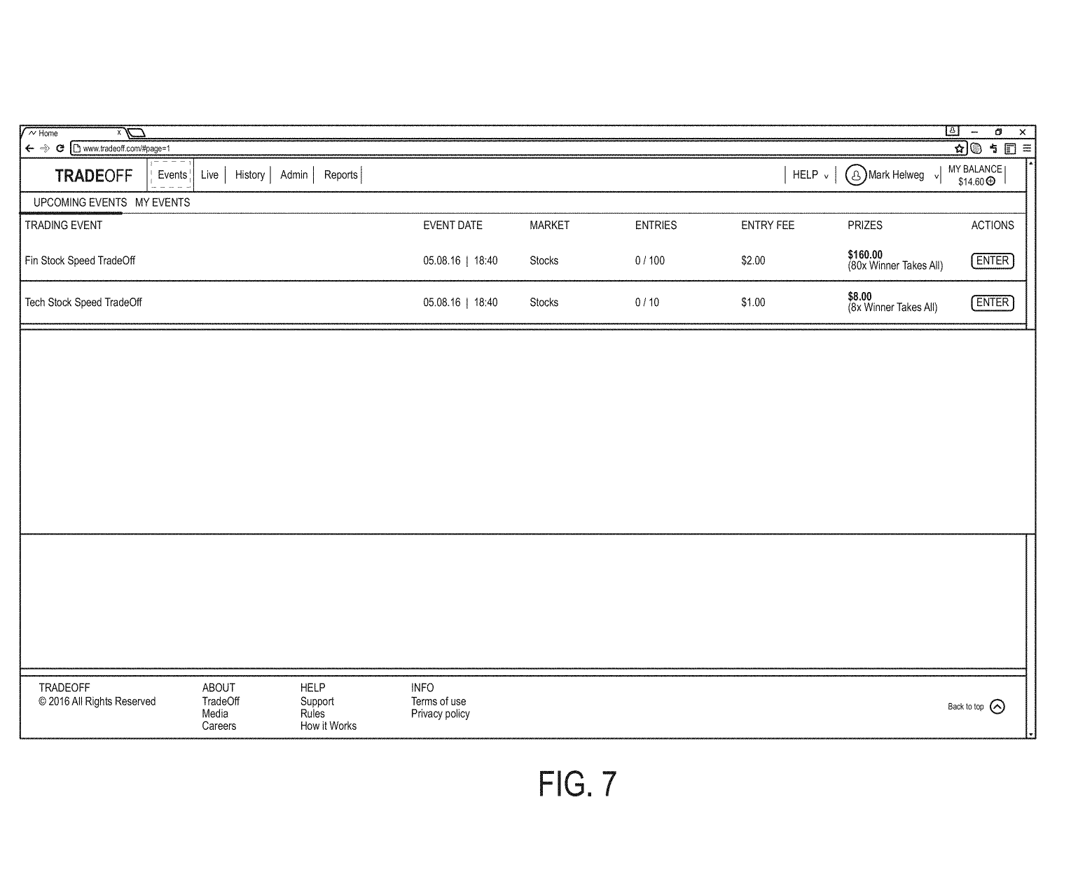

FIG. 6 shows a flow chart of steps performed in a “Request” competition flow, in the speed trading system. At step 74, competition parameters are defined. Next, at step 76, a request is made of the speed trading server to start a competition and thereafter, a competition is built. Next, at step 80, the price data for the competition is retrieved. This is the same as the market data that is included in the historical data server. The server 94 is intended to represent the historical data server. Next, at step 82, the quality of the price data is checked and if any errors are found, at 98, the data is repaired and the repaired data replaces the data with error in the price data server 94. When there are no more errors, after 98, step 84 is performed where accelerated data is streamed for competition. This is data from historical data that is collected over a period of time. For example, historical data may correspond to trade (or stock) information over a two week period of time. Whereas, this data is all available for trading and can be used to do the same in an event that lasts a few minutes, perhaps. The trading competition begins at step 86 and at step 51, the competition data is processed and the processed data is stored in the database 53. Next, the competition winners are determined at step 88 and a winner is determined at 90, if there is one and if there is none, the process ends. In the case where a winner is determined, cash prize, for example, is transferred to the winner's account at step 92 and the process ends.

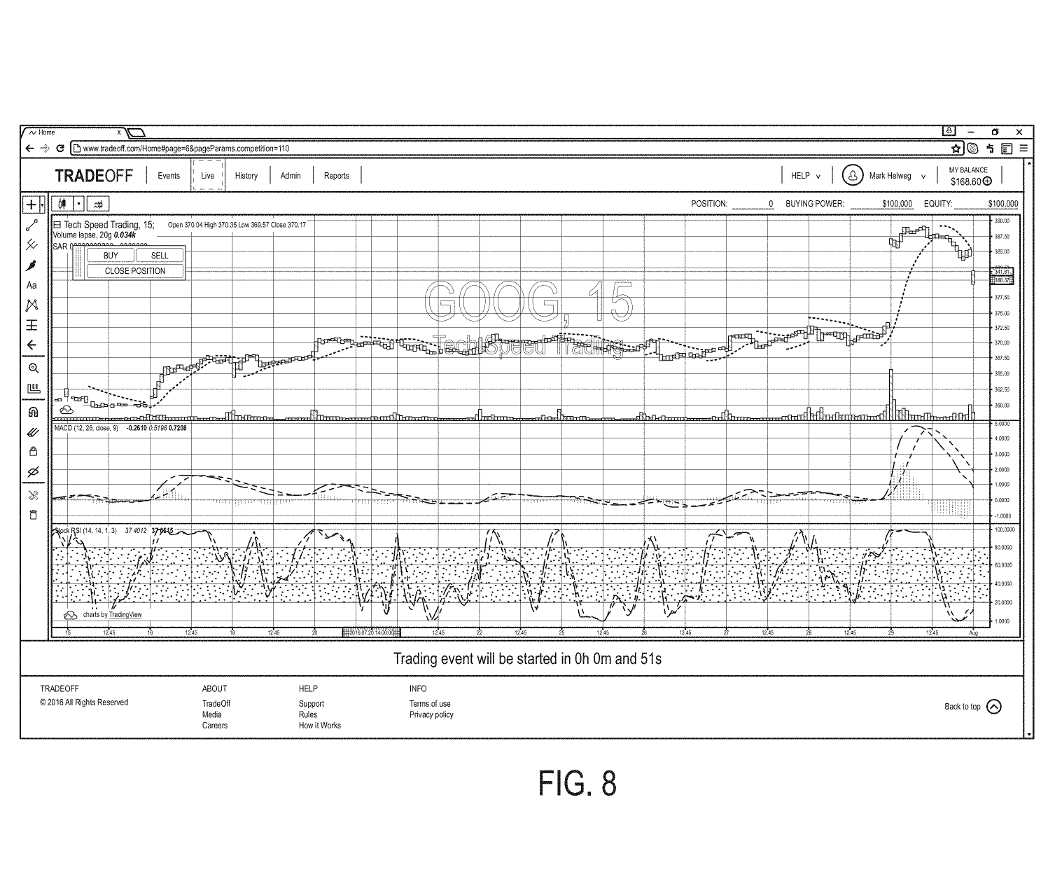

FIG. 7 shows exemplary speed trading competitions displayed in an “Events” tab for the benefit of a trader. At this point, traders can sign up to compete in competitions.

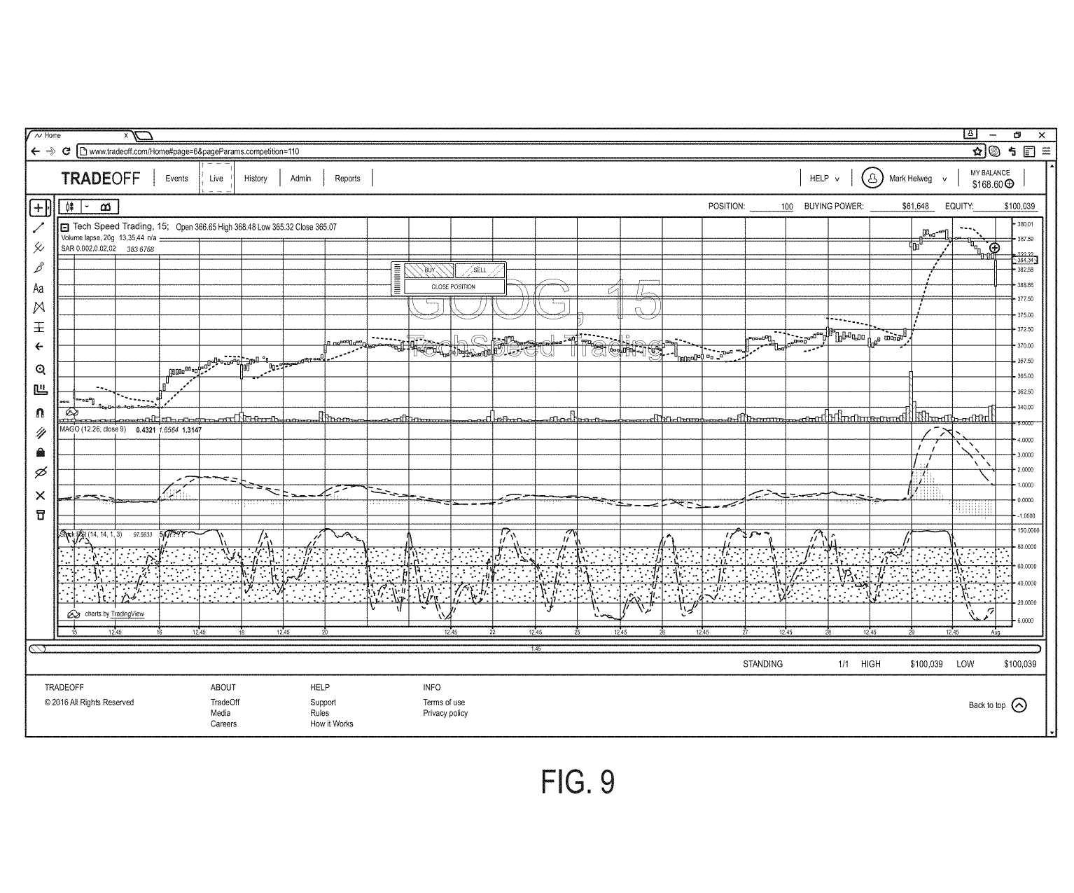

FIG. 8 shows a graph of the status of an exemplary speed trading competition before the competition begins. Traders can add technical analysis tools, of their choice, to this graph, which can alternatively be a chart. The competition countdown clock is displayed at the bottom of the chart.

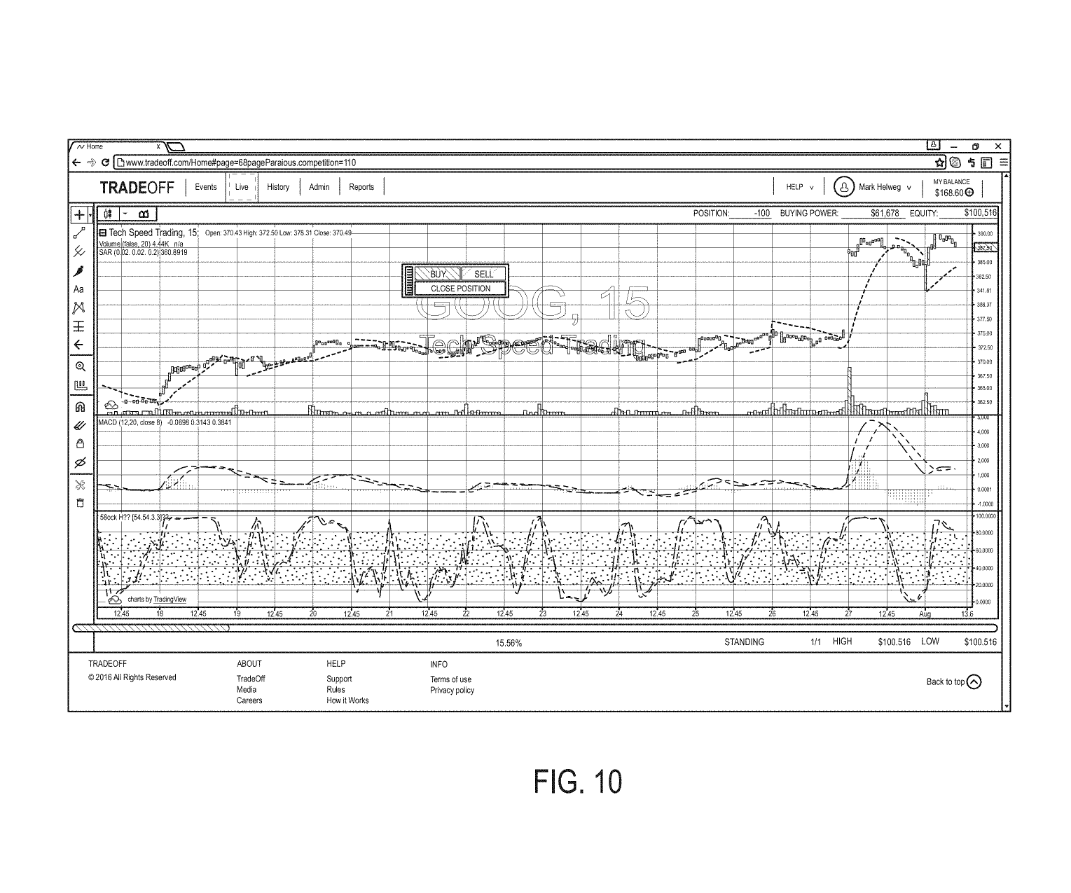

FIG. 9 shows an exemplary speed trading competition chart during a live competition.

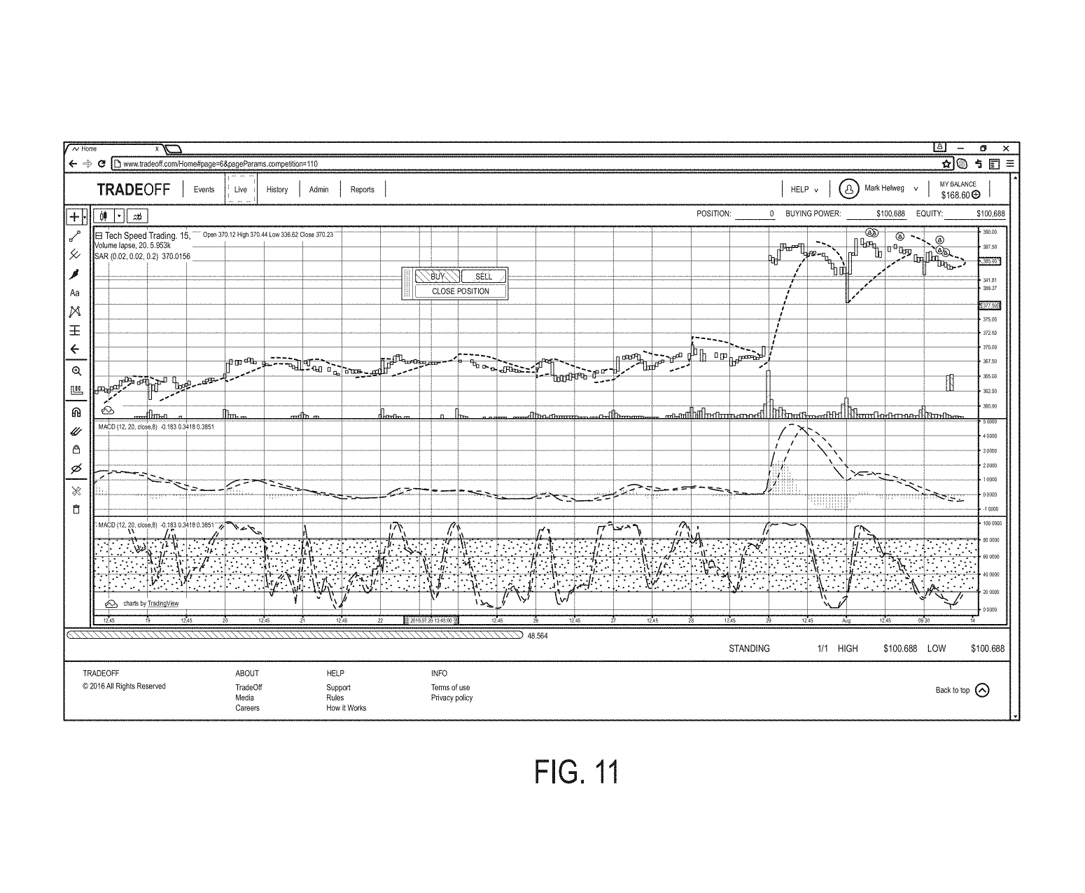

FIG. 10 shows an exemplary speed trading competition chart during a live competition. Notice the progress bar positioned at the bottom of the chart window to communicate the progress of the competition through to completion of the competition.

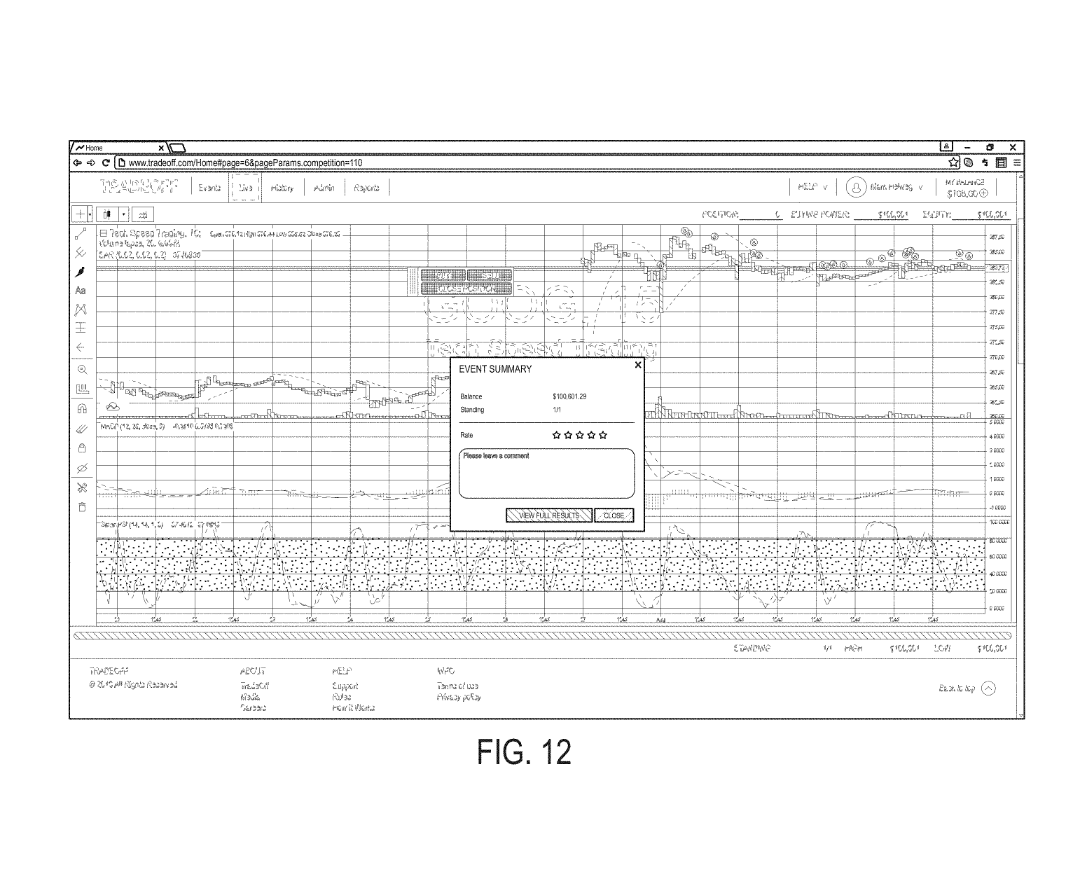

FIG. 11 shows an exemplary speed trading competition chart during a live competition. Notice “buy” and “sell” arrow markers above the “price” bars where a trader has generated “buy” and “sell” orders during the speed trading competition.

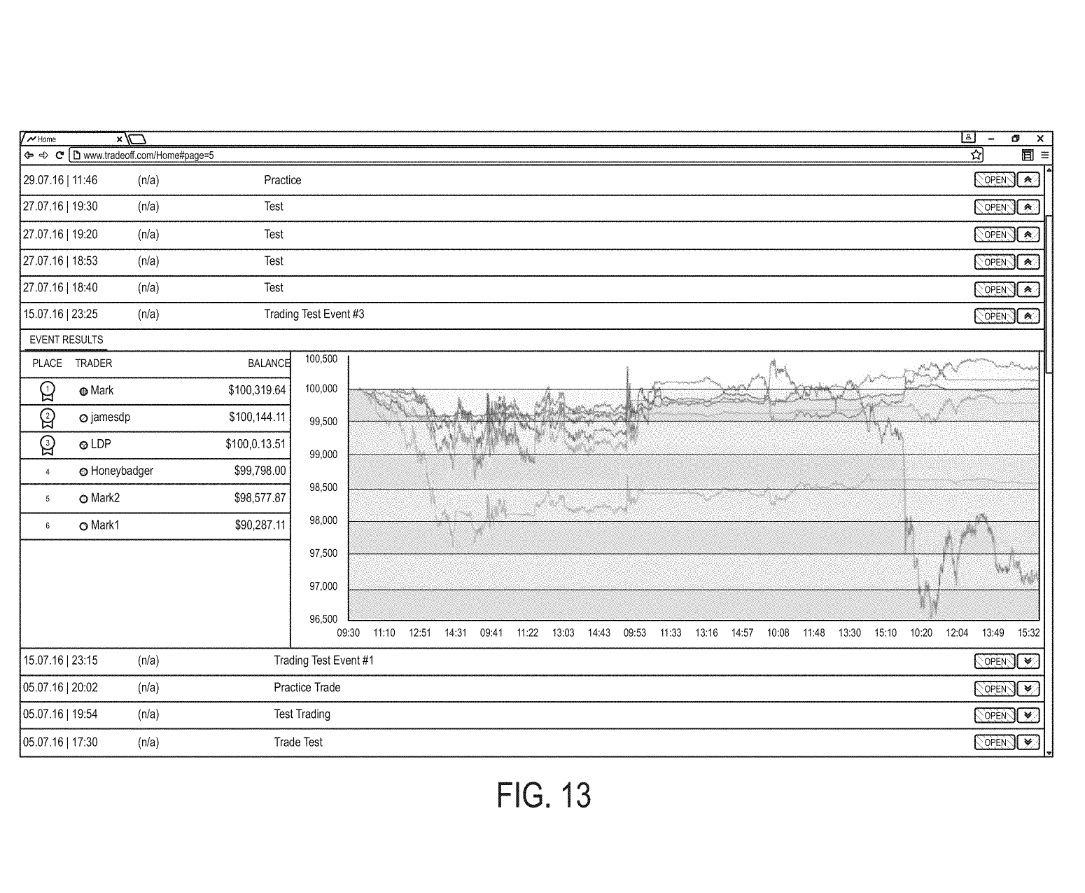

FIG. 12 shows an exemplary speed trading competition chart after a competition has concluded. Traders have the option to leave feedback and rate the competition.

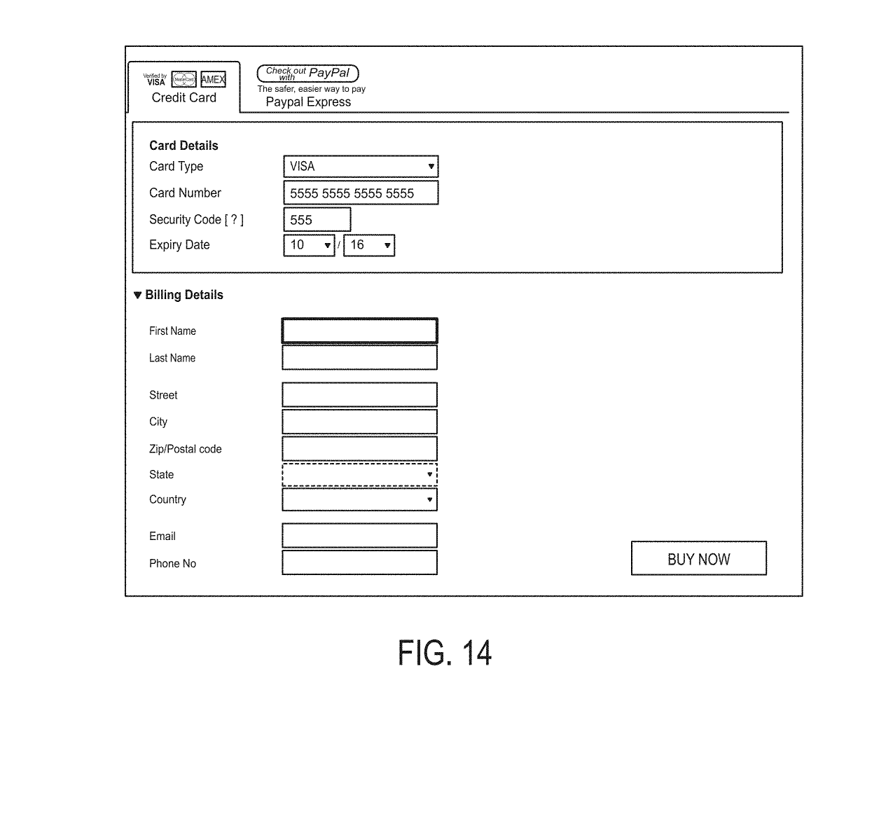

FIG. 13 shows an exemplary speed trading competition results page after a live competition has concluded. Traders have the option of viewing their rank against other traders' ranks and view their performance using equity curves during the speed trading competitions.

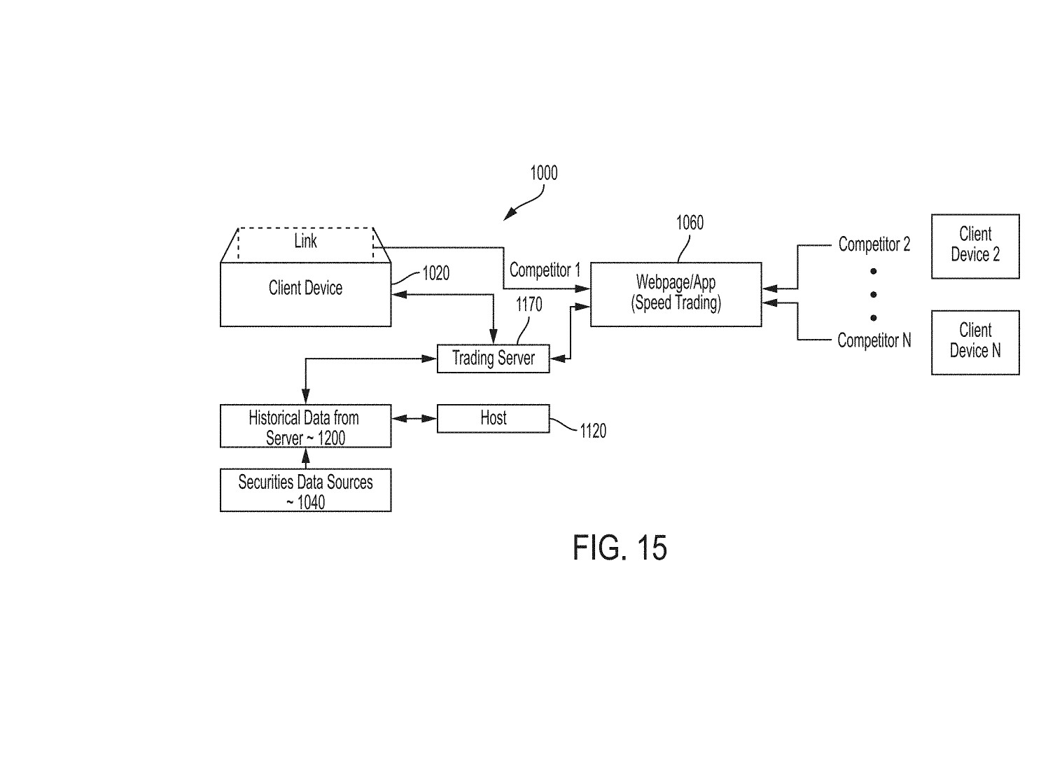

FIG. 14 shows an exemplary merchant services screen displaying money added money to a trader's account for cash prize competitions.

FIG. 15 shows a trading system 1000, in accordance with an implementation of the disclosure. The trading system is shown to include a client device 1020, a historical data server 1200, a security data source 1040, trading server 1100, a computing device 1060 with a webpage, and a host 1120. The client device 1020 may be any user device that can be used to communicate with another device and internet-ready, such as a smartphone, tablet, or personal computer. The host 1120 may be a processor or include a processor, such as a laptop, networking equipment, personal computer and the like. The historical data server 1200 receives historical securities data from the security data source 1040. The security data source 1040 provides various types of quantitative information about securities, from one or more sources, such as Bloomberg, Fidelity, NASDAQ, and or a host of other sources.

In accordance with various implementations, the invention presents a fantasy trading competition utilizes randomly selected past market data from actual historical market data, collected from actual trading houses or data vendors. During a competition, the trade data/graphs are streamed to the players in real time.

The historical data server 1200 may be employed to save the historical securities data (or quantitative values), such as the price and volume of a security at a particular time, of a security, such as stock. Although other storage devices may be employed to do the same. The historical securities data and associated parameters are processed by the server 1200 and ultimately sent to the trading server 1170. A user of the client device, such as one of the players of the trading competition trades securities at the web page/application 1060 through the client device 1020. In accordance with exemplary implementation, the host 1120 or the client device 1020 may initiate competition. In the latter case, this may happen by the click of a button on the webpage/application 106 and in the former case, the host schedules competitions to begin automatically or manually initiates competition.

The competition may be started by use of an “event”. In the case where the client device starts a competition, the user of the client device 1020, clicks a button on a webpage or an application being viewed by the user, such as the webpage/application 106. In the case where the host starts a competition, the host 1120 communicates the event parameters to the historical data server 1200 through a webpage/application over an internet or intranet. As shown in FIG. 15, other competitors, competitors 2 and 3, may also compete, in which case, the webpage/app 1060 is not necessarily a part of the client device 102 and rather may be a part of another device capable of presenting streamed data to the competitors and essentially hosting the competition through the device of which it is a part. While three competitors are shown in FIG. 1, it is understood that any number of competitors may compete in the trading competition.

The server 1200 retrieves securities, for example, in the case where the security is stock, the stock price level, period of time when the price level and other information was collected, volume, volume history, market capitalization, and volatility of the stock for the same period is collected by the server 1200—quantitative data—from the securities source 1040. The server 1200 processes a part of this information in such a way as to disguise it from the players/competitors 1-3, in this example. Therefore, when the players start to trade, they are oblivious of the actual data, such as the actual securities price, historically traded, because the information presented to them on their screen is modified and disguised to the stock information they would have been privy to if they had participated in an actual trade.

More specifically, an event manager or competition creator/initiator, such as the host 112 or competitors 1-3 (as shown in FIG. 15) send a competition request to the server 120. The request includes competition parameters relating to one or more securities for one or more requested competitions. The competition parameters can be applied to a number of competitions scheduled around the clock or during certain defined times/dates. Examples of competition parameters include:

Competition Length in Minutes and Seconds

Price Bar Updates per second (impacts the smoothness of the streaming data)

Price adjustment up or down by N % (or this can be random)

Stream Speed (Bars per Second)

Name of Competition

Description of Competition

Exclusivity (Open or Private Competition)

Entry Fee

Number of Participants (Defined or unlimited)

Payout structure (Free, Winner Takes All, Tiered to Top N %, Flat to top N %, Top N, etc.)

Adjust Close to Open Gaps (Yes or No)

Competition Special Designs or Constraints

Tournament (Yes or No)

League (Yes or No)

In another implementation, the source 1040 is retrieved periodically, upon request, or yet only when needed such as once per month or per day. Thus, to avoid unnecessary delay yet maintain fairly recent real securities information, a user of system 1000 can program the retrieval of this information, as desired. Alternatively, historical data from the source 1040 is transferred in bulk and periodically, or not, to the server 1200 and processed thereafter. The parameters are sent by a user/player/competitor or host and an event is constructed from these parameters. While the goal is to obscure the actual traded securities data as much as possible, in actuality, a balancing act needs to be performed between obscuring the real data and maintaining its resemblance to the real data because trading competitions want to preserve the true character of each market as they reflect the human emotions of greed and fear over time. Therefore, a balance is struck between the resemblance of the real data, enough to preserve the characteristics of real markets and disguising the real data as much as possible.

The data, in the system 1000, starts from actual historical marketplace data, which is saved in the server 1200, i.e., the data actually traded in the securities market in real time. As an example, Apple's stock, when it was initially traded two weeks ago and Amazon's stock, when it was traded during the same time interval is the data saved in the server 1200. Therefore, the server 1200 obtains real securities data that was traded in the past. The historical data, in addition to not being current, is obscured in numerous ways before being streamed to the players to further reduce the risk of cheating. In fact, access can be limited to certain parts of the processing of the server 1200.

Upon the start of an event, a round of competition begins and takes place through the trading server 1170. In an exemplary implementation, the competition is performed through speed trading, in accordance with the disclosure of U.S. Provisional Patent Application No. 62/412,251, filed on Oct. 24, 2016, by Robert Kuck, and entitled “ACCELERATED STREAMING PRICE CHART DATA FOR TRADING COMPETITIONS”.

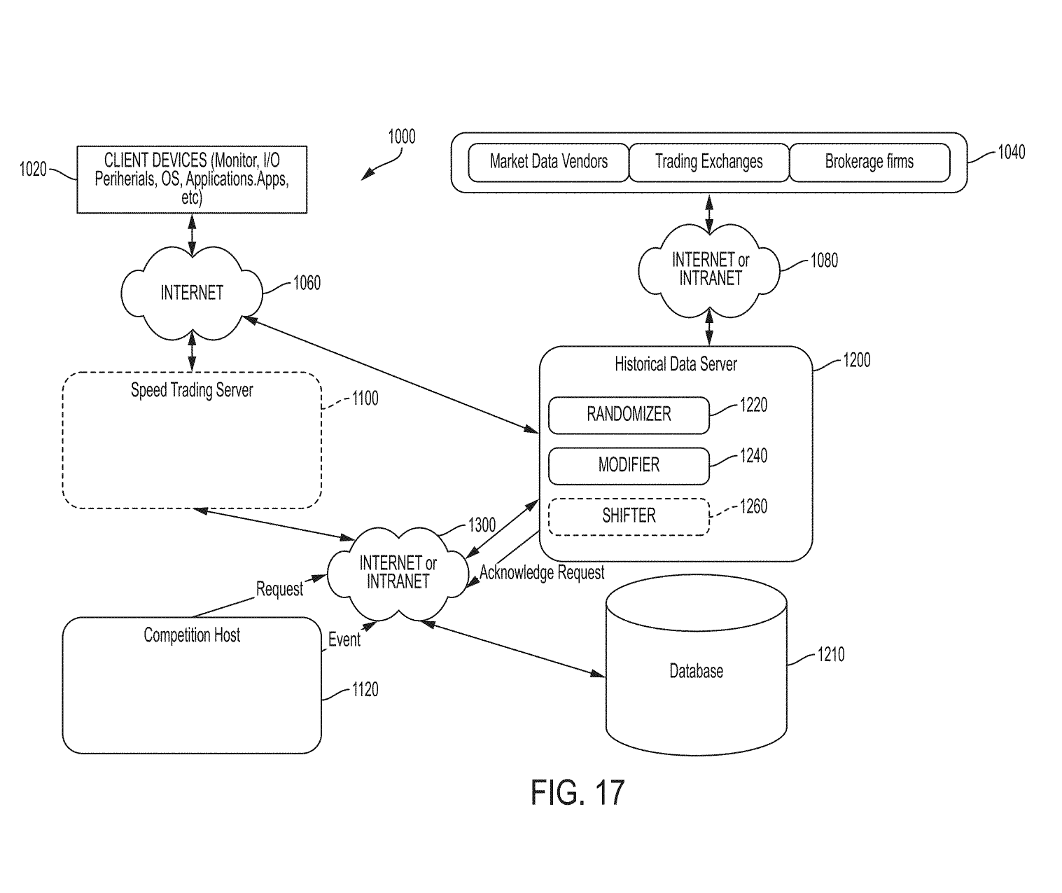

FIGS. 16 and 17 each show further details of the system 1000 of FIG. 15, in accordance with various implementations of the invention. FIG. 16 is analogous to FIG. 1 except that the servers 1100 and 1200 are shown with greater detail. Additionally, information flow is shown to travel generally through the Internet/Intranet, i.e. 1060, 1300 and 1080 or the Cloud. Also shown in FIG. 16 is historical securities database 1210. While the database 1210 is shown to be a part of the server 1200 in FIG. 16, it is understood that it may be located externally in other implementations. The database 1210 houses the historical securities data retrieved and employed by the server 1200. In various implementations, it may be located within the server 1200 or other locations in the system 100 that is suitable for a database.

The server 1200 is shown to include a randomizer 1220, a modifier 1240 and a shifter (also referred to herein as “adjuster”) 1260. The modifier 1240 may include a combiner, a splicer, changer, and the like, that causes selection of one or more securities during the same or alternate periods of time, among a host of other functions that can be performed on securities.

In FIG. 16, the client device 1020 is shown to communicate with the speed trading server 110 and more specifically, with the historical trading server 1200, through the internet/intranet 1060. The client device 1020 is also shown to be communication with the historical data server 1200. The servers 1200 and 1100 may also communicate with each other through the internet 1300 or other medium. The host 1120 is shown to communicate with the server 1200 through the Internet 1300. The securities source 1040 is shown to communicate with the server 1200 through the internet/intranet 1080.

During operation of the system 1000, the host 1120 may automatically, through scheduling, or non-automatically, send the server 1200 a request for an event and upon acknowledgement of the request by the server 1200, the competition is scheduled or begins. This is perhaps best shown in FIG. 17. Alternatively, a user of the client device 1020 clicks on an event button to start the competition.

The historical securities data, stored in the database 1210, originates from the market data vendors (sources) 1040 and accessed by the server 1200. Once the competition begins, historical securities series, maintained in the database 1210, is accessed by the server 1200. This does not necessarily mean that every time competition is about to start, data is downloaded from the sources 1040 to the database 1210. Indeed, this is not at all necessary and is rather cumbersome and time consuming. More practically, data is downloaded periodically or otherwise, as deemed necessary by the designer of the system.

The server 1200 is shown to include a randomizer 1220, a modifier 1240 and a shifter (also referred to herein as the “adjuster”) 1260. Alternatively, the server 1200 may not have the shifter or even the modifier at the cost of less obscurity of the securities data, risking cheating by others.

Upon receipt of an event, the randomizer 1220 randomly selects a number of historical securities data from the historical securities data that was last downloaded from the securities sources 1040. The number of historical securities series or historic securities data (or “series”) can be any number greater than or equal to two because at least two securities are needed in most cases for the operations ahead to make sense.

The randomizer 1200 examines the randomly-selected historical securities for meeting certain conditions. Conditions can include finding historical securities data with higher levels of directional volatility in order to make trading competitions more exciting. Thus, the output of the randomizer 1220 is randomly selected historical securities data and received by the modifier 1240. This randomization process remains unknown to the players/competitors. In fact, all other operations on the historical data that are discussed herein produce outputs that are invisible to the players and the more functions performed, the better the quality of the disguising of the data.

The randomly selected historical securities series from the randomizer 1220 are then either modified and optionally shifted. Depending on the modifier method selected, the modifier 1240 combines at least one of the randomly selected historical securities series with another one or more of the randomly selected historical securities series, both selected by the randomizer 1220. The modifier may combine more than two securities together. Upon combining two or more of the randomly selected historical series, essentially a synthetic version of actual, but outdated, securities and their associated parameters is generated. The synthetic securities series is transmitted by the modifier 1240 to the shifter 126 for further processing.

The modifier 1240 may also apply weights from the randomizer 1220 to the stock price as a multiplier. This effectively scrambles the true stock price and has another added benefit, demonstrated in the following example. In a case where Apple's stock is trading at a price that is 20 times the stock price of General Dynamics, the influence of General Dynamics compared to Apple when combined together would not be significant. However, when a weighting is applied which would multiply the General Dynamic price series by 20 times, it would then impact the average or the two stocks more significantly, which would serve to more effectively disguise the new resulting synthetic security series. Weighting involves multiplying, for example, a value representing the assigned weight to a value representing the lower-priced stock(s) so as to equalize the prices of all stocks so that all stock prices are the same price level as the highest-priced stock. By way of example, if Apple Inc.'s stock, AAPL, is trading at $100/share and Google, Inc.'s stock, GOOG, is trading at $600/share, the price of the AAPL stock is multiplied by 6 while the price of the GOOG stock is multiplied by one or remains the same. In this manner, the AAPL price series appears to trade around $600/share. By doing this, a high priced-stock does not overwhelm the influence of cheaper-priced stock(s). If the lower priced stock is selected as the reference stock, then the higher priced stock could be divided by a factor to achieve a similar result. If the server 120 does not weigh stocks, and if the randomizer selects GOOG at $600/share and for example, the price of Ford's stock is at $10/share, the influence that Ford would have if not weighted would be next to nothing, as if an additional stock is not averaged at all because GOOG is so much higher in price/share and so much more volatile. Still other manners of scrambling the data or combination thereof may be done. For example, a formula that changes the price series by changing the magnitude and direction of incremental price moves within a security series may be applied.

The shifter 1260 shifts or adjusts the synthetic securities series in one of various optional manners, such as shifting the period of time when a security was traded to another period of time and/or adjusting the price level of a security either up or down. Another example is adjusting the price level of one of the securities and introducing a time delay to it. For example, the time period during which a particular stock was actually traded is altered. This further obscures the price of a security at the actual time of trading. An outright shift of the entire price series along with adjusting volume is another way to shift a security series.

Alternatively, the shifter 1260 may be employed to process the data before the data is combined by the modifier 1240. In other words, the shifter 1260 receives the output of the randomizer 1220 and the output of the shifter is received by the modifier 1240.

In FIG. 16, optionally, the server 1100 is absent and the client device 1020 communicates with the server 1200 through the internet 1060, as shown in FIG. 16.

The client device of each competitor, which may be more than one client device, may have an application on a smartphone as the client device or an operating system with programs being executed on a personal computer with a monitor and input/output peripherals for use with competing.

The securities source 1040, in FIG. 16, is shown to include market data vendors, such as Bloomberg, Morning Star and the like, and trading exchanges, such as NASDAQ, Dow Jones, Standard and Poor's Index. Additionally, the securities source 1040 is shown to include brokerage firms, such as Fidelity and Charles Schwab as sources of the securities or studies/research thereof. The competitors have the option of using research and other information supplied by these vendors during, before or after trading. The output of the securities sources is passed onto the historical data server 1200 through the internet/intranet 108. It should be noted that during competition, the output of the shifter 1260 or any other output from the server 1200 is streamed, in real time, to the competitors. They can also have access to graphs, charts, . . . , just as they would if they were real-time trading.

Other examples of “securities” include forex, futures and options.

FIG. 17 is analogous to FIG. 16 except that the database 1210 is shown externally placed relative to the server 1200 and further details of the communication between the host 1120 and the server 1200 are shown. The host 1120 may automatically, through scheduling, or non-automatically, send the server 1200 a request for an event, through the internet 1300. The server 1200 receives the request and sends back an acknowledgement (to the request) back to the host 1120. Upon receipt of the acknowledgment by the host 1120, the host 1120 begins the competition. Alternatively, the server 1200 or even a player or server 1100 may start the competition.

FIG. 17 shows yet another example of the implementation of system 1000. For example, the server 1100 is shown to include a competition host 1120, which is the host discussed relative to FIG. 16 above. The host 1120 is shown to send a Request through the internet 1300 to the server 1200, receives an Acknowledge Request back from the server 1200, and initiates an Event accordingly.

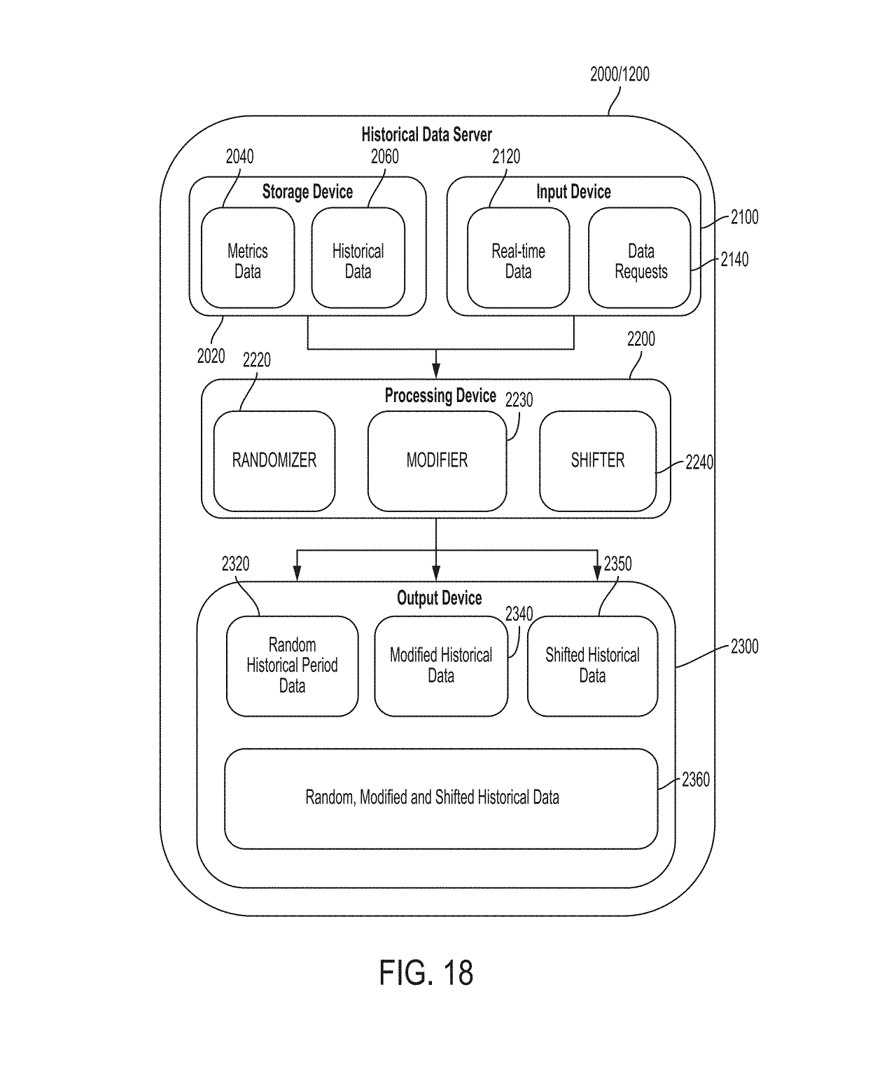

FIG. 18 shows further details of the historical data server 1200 (also referenced as “200” in FIG. 18), in accordance with implementations of the disclosure. In FIG. 18, the server 2000 is shown to include a storage device 2020, an input device 2100, a processing device 2200, an output device 2300, and synthetic historical securities 2360. In the output device 2300, one or more processes can be applied to a data series or all processes, including the randomizer, modifier, and the shifter, can be applied to a data series as reflected by 2360. The storage device 2020 is shown to include metrics data block 2040 and historical data block 206 and the input device 2100 receives real time data 2120 that is the actual securities and in real time. The metrics data block 2040 maintains the metrics of securities, such as volume, market capitalization, price level, volatility, among other metrics. The historical data 2060 maintains historical information about securities, such as price at a particular point in time. An example of another historical data series that can be manipulated is volume. Metrics data and historical data are streamed in real-time.

Input device 2100 includes a real-time data block 2120, which provides data, such as the price and volume of a security, in real-time. Accordingly, the outputs of both the storage device 2020 and the input device 2100 are streamed in real-time, optionally to the display of the client device 1020 used by competitor 1 in FIG. 15, for example.

Referring back to FIG. 18, the output of the storage device 2020 and input device 210 are provided to the processing device 2200, which is shown to include the randomizer 2220 (or randomizer 1220 in FIG. 16), the modifier 2230 (or modifier 1240 in FIG. 16), and the shifter 2240 (or shifter 1260 in FIG. 16). The functions of these three processors are discussed above relative to FIG. 16.

The output of each of the randomizer 2220, modifier 2230, and shifter 2240 is provided to the output device 2300, which is shown to include a random historical data period information 2320, modified historical data 2340, and shifted historical data 2350, or all three processes combined and collectively referred to as the random, modified and shifted historical data 2360. The random historical data period data 2320 is the output of the randomizer 2220, the modified historical data 2340 is the output of the modifier 2230 and the shifted historical data 2350 is the output of the shifter. Accordingly, the output of all of the blocks 2320, 2340, and 2350 is a random synthetic securities historical data with shifting, at 2360.

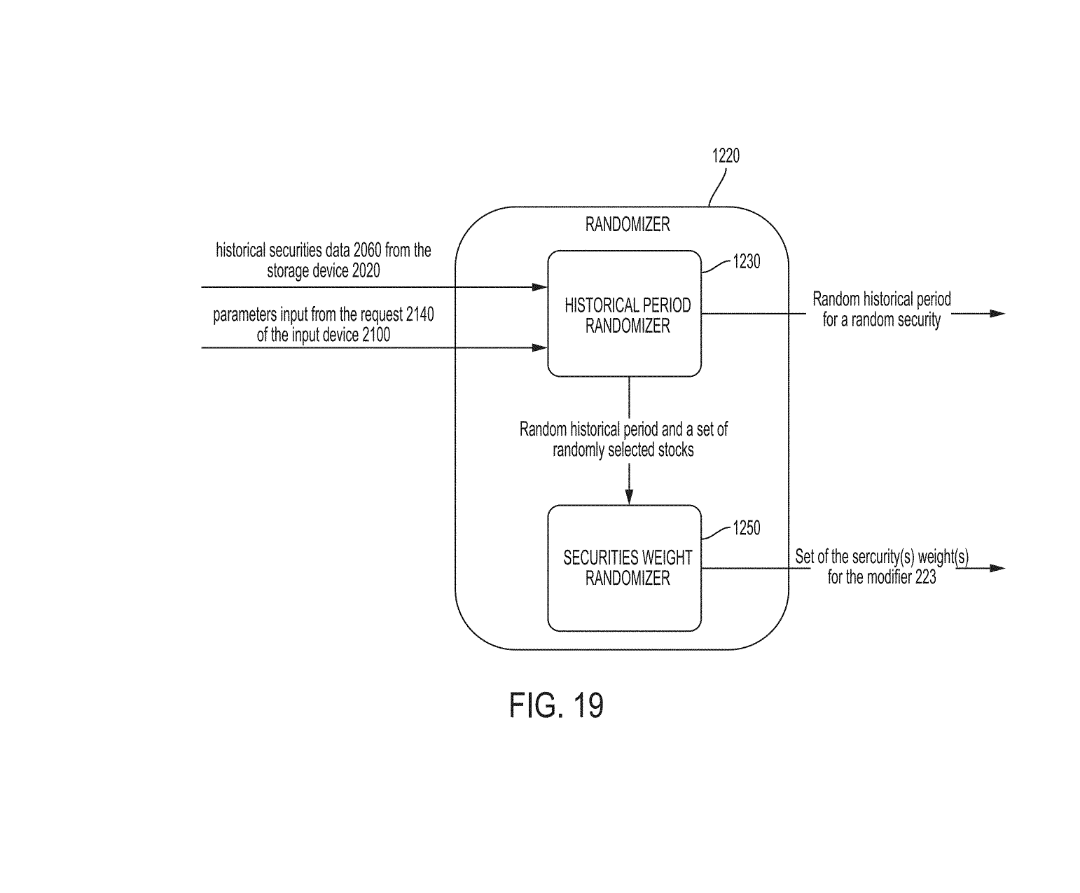

FIG. 19 shows a block diagram of further details of the randomizer, in accordance with various implementations of the disclosure. The randomizer 1220 is shown to include a time randomizer block 1230 and a weighting block 1250. The block 1230 feeds the block 1250. The inputs to the randomizer 1220 come from the client device 1020 and securities source 1040, as shown in FIG. 16. One of the inputs is historical securities data provided by vendors, such as the securities source 1040, shown in FIG. 16, and the other input is metrics data from the client device 1020 and the competition host 1120, also shown in FIG. 16. Both inputs are provided to the time randomizer block 1230, which identifies a historical period of time, on a random basis, that satisfies the requested metrics. The requested metrics is the metric input from the client device 1020 or the competition host 1120. As an example, a number of securities (the historical securities data received from securities source 1040) is randomly selected, at a particular period of time, also randomly selected. The selected securities at the selected period of time however, may need to meet certain requirements, dictated by the client device 1020 or the competition host 1120, such as having a particular market capitalization or volume.

Metrics are calculated by the server 1200. These metrics can include, for example, the length of the competition (like 5 minute and 30 seconds) and price bars, for example, 15-minute price bars, 30-minute price bars, or 60-minute price bars can be used.

In an implementation of the invention, a set of randomly selected securities, at a randomly selected period of time, is allocated a distinct weight. For example, a stock from the set with a price that is multiple folds higher than the price of another stock in the set may be given a lower weight in order to balance the contribution of each stock.

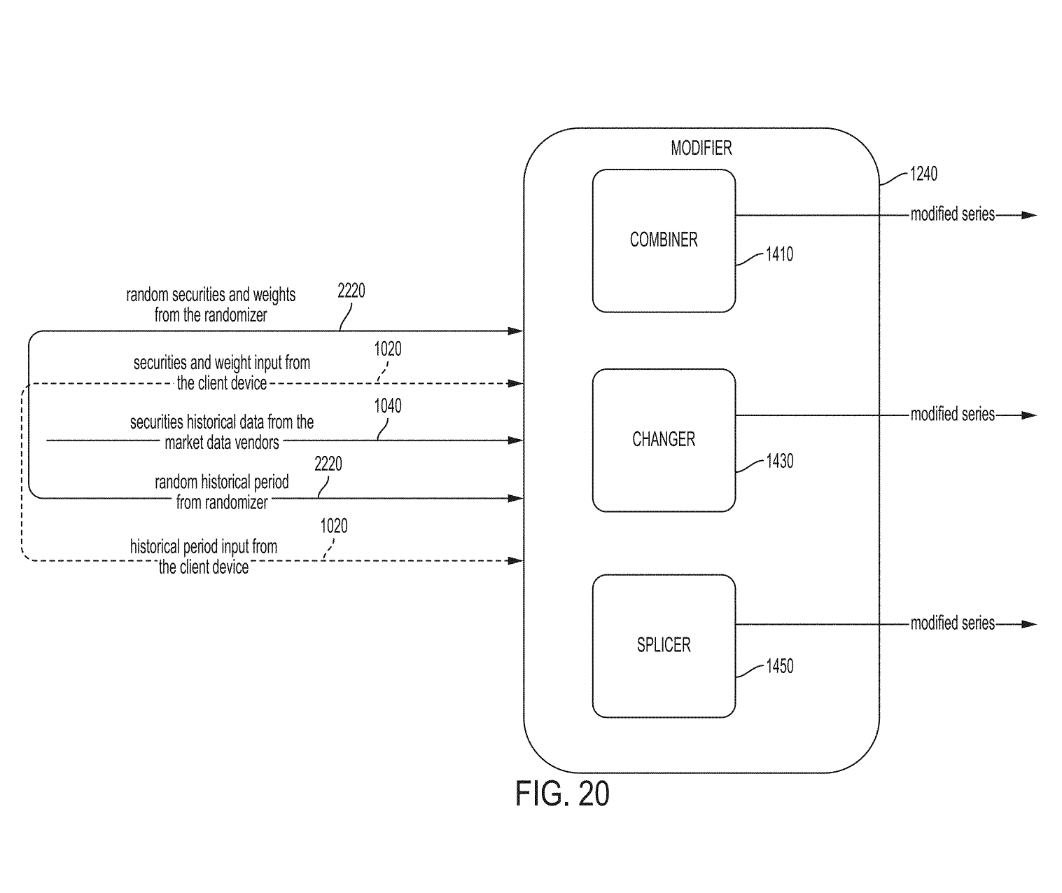

FIG. 20 shows a block diagram with further details of the modifier, in accordance with various implementations of the disclosure. In FIG. 20, the modifier 1240 is shown to include a combiner 1410, changer 1430, and splicer 1450. Further details of each of the combiner 1410, changer 1430, and splicer 1450 is presented and described relative to subsequent figures. The modifier 1240 is shown to receive, as input, randomized securities and weights from the randomizer 2220 (or the output of the randomizer 2220), shown in FIG. 18, and stocks and weights from the client device 1020 or the host 1120. The securities and weights can be generated by a player or host, such as the player of client device 1020 or host 1120. The block 1410 assigns each security, received from the randomizer 2220, that is being ‘combined’ a unique weight.

Each type of method employed by the modifier is either mutually exclusive or utilized collectively. If the combiner method is used to disguise data, then the randomizer 2220 selects 2 or more securities data series to combine into one series

The modifier 1240 applies the weights to calculate the combined securities and generates a synthetic random securities. The changer 1430 also receives as input, a randomized historical security data from the randomizer 2220. The changer 1430 adjusts or modifies the output of the randomizer 1220, those from the client device 1020, and those from the securities source 1040 and applies an algorithm to change the characteristics of the price series, received from the randomizer 1220, to aggregated new modified securities set. The splicer 1450 selects or cuts the output of the randomizer 2220. Depending on the process that is selected between the combiner 1410, changer 1430 and splicer 1450, the modifier outputs as the output of the modifier 1240.

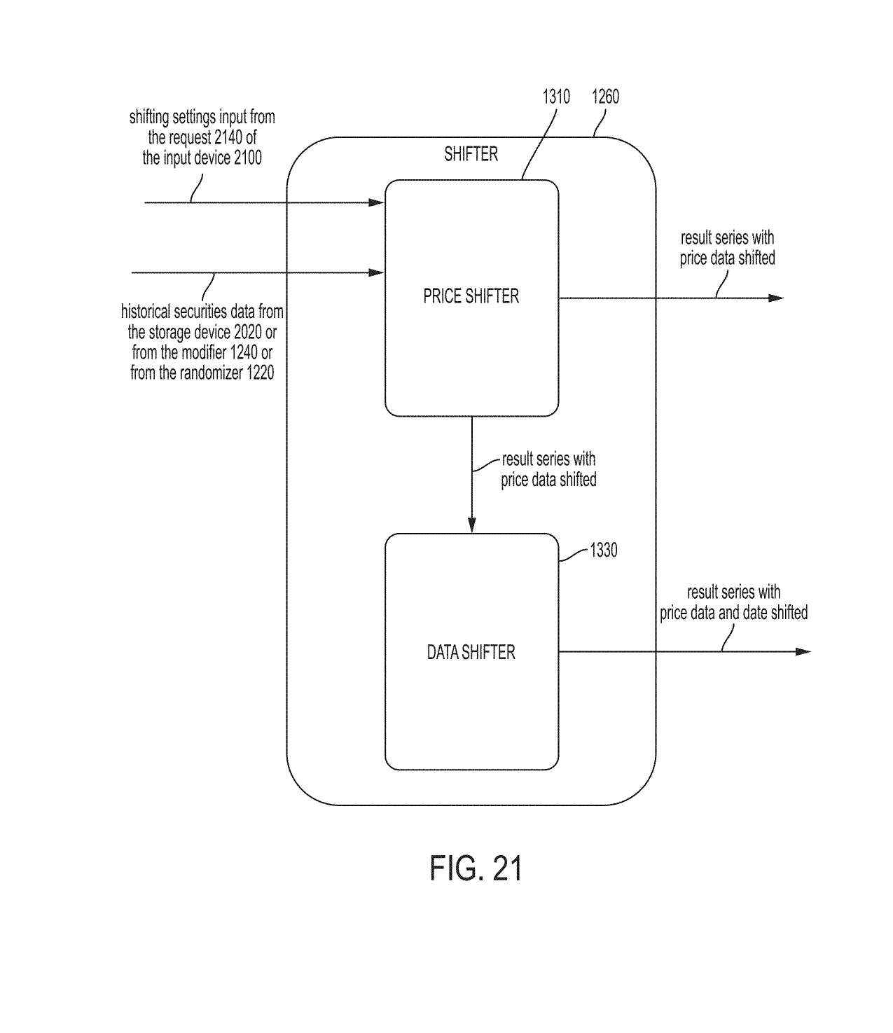

FIG. 21 shows a block diagram of further details of the shifter 1260, in accordance with various implementations of the disclosure. Blocks 1310 and 1330 adjust securities series price and date, respectively. The goal is for the securities price to be adjusted up or down to prevent traders (or competitors) from easily recognizing it, as dictated by the parameters. For example, the historical dates of all randomly-selected stocks may be adjusted by making the dates current. If the price of Amazon, Inc., AMZN, for instance, from the second week of January 2004 were adjusted, the dates would be shifted so that they appear as if this stock series traded in July 2017.

Parameters can include, for example, the rate (speed) of a data stream, like one 30-minute price bar per 2 seconds. These parameters are required to determine the amount of data history needed to be collected by the randomizer 1220 within the server 1200.

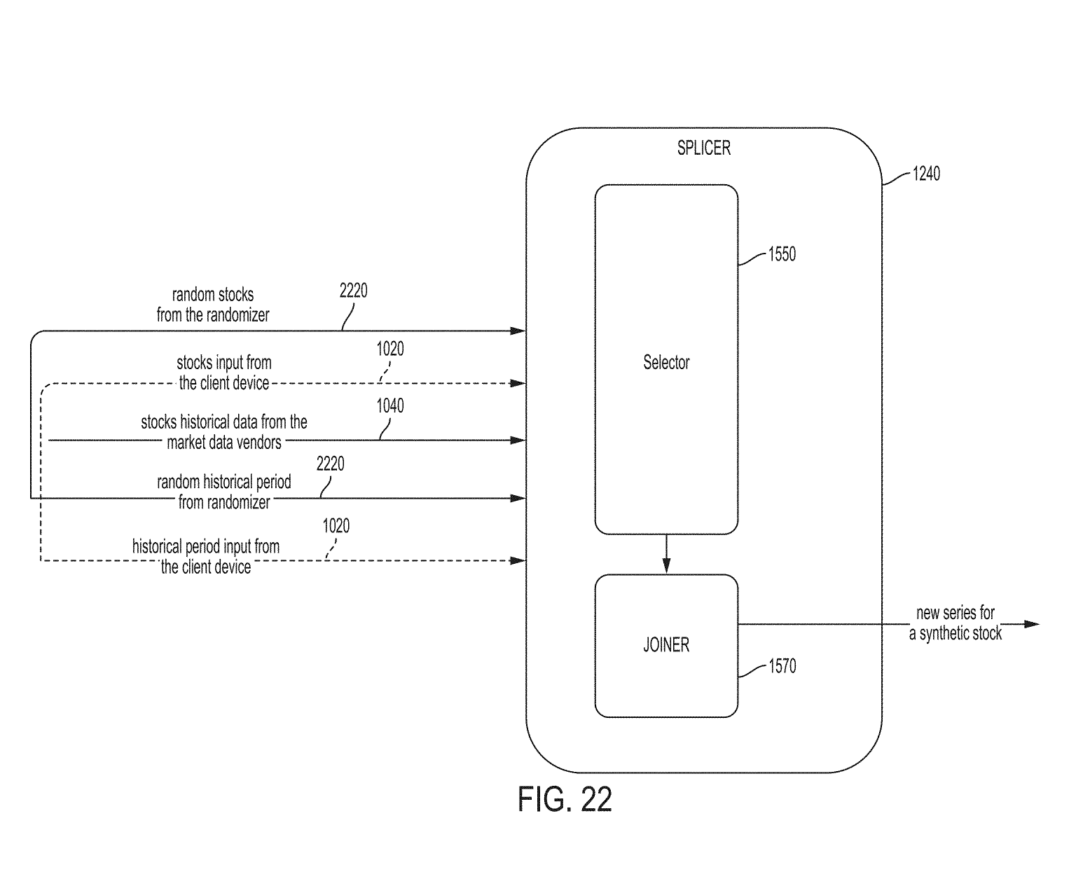

FIG. 22 shows a block diagram of further details of the splicer, in accordance with various implementations of the disclosure. The splicer 1240 is shown to include a selector 1550 and a joiner 1570. The selector 1550 receives the output of the randomizer 2220, which includes randomized securities, such as stocks, and randomized historical period during which the securities from the randomizer is recorded. Additionally, competitor 1's choice of securities and a historical time period are received from the competitor's client device 1020. The selector 1550 generates historical securities (data) by selecting a part of one historical securities from the randomizer 2220 and selecting a part of one or more additional historical securities also from the randomizer 2220. The selected securities segments are then spliced together by the joiner 1570 to create a new synthetic securities contract. Similarly, a selection is made as to the period of time (or window) during which the selected securities are recorded. The output of the selector 1550 is provided to the joiner 1570 where the function, such as every other data point, is actually performed. The price gaps between securities will be removed by shifting the price level or one or more of the securities to the equivalent price level. In this respect, a new securities series for a synthetic series is output from the splicer 1240.

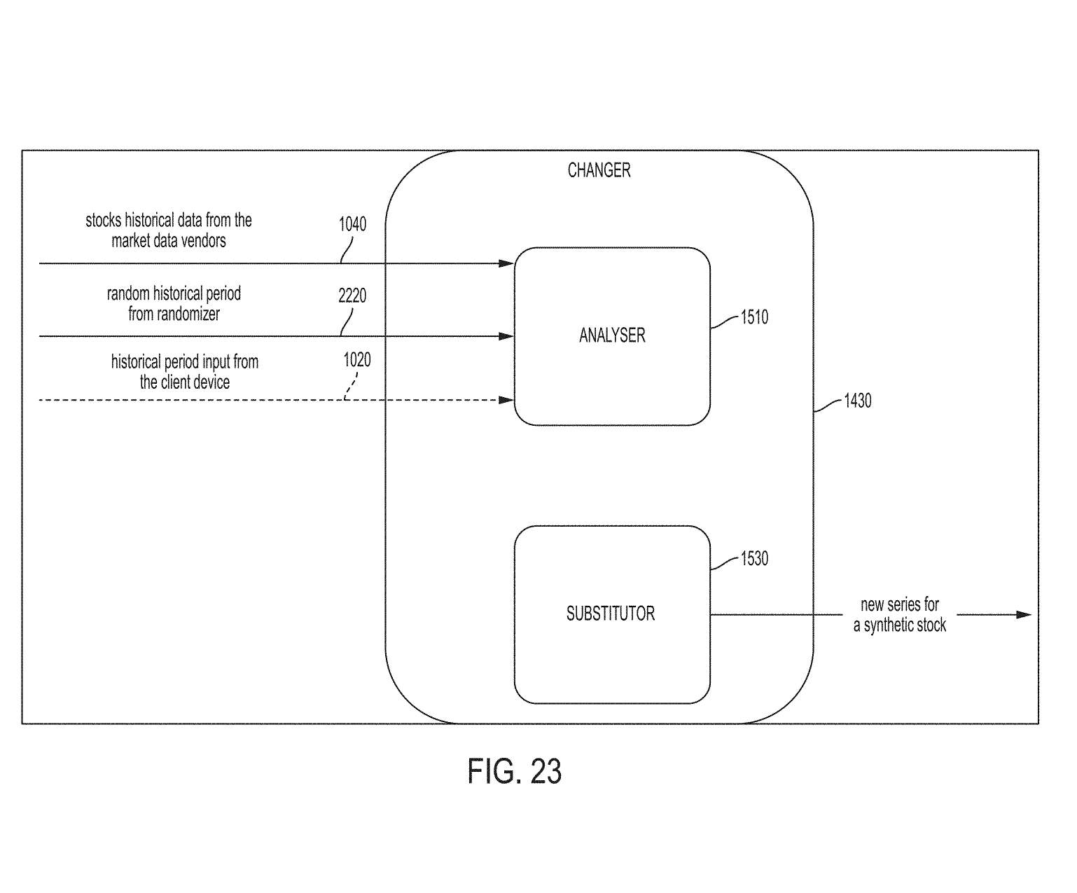

FIG. 23 shows further details of the changer 1430, in accordance with exemplary implementations of the invention. The changer 1430 is shown to include an analyzer 1510 and a substitutor 1530. Historical securities information from the sources (or vendors) 1040 is received by the analyzer 1510 or by the randomizer 2220 or received by the client device 1020. The analyzer 1510 processes the received historical securities information in accordance with one of various processes, such as without limitation, altering the magnitude or direction of various price bars or data points contained within a securities series. The substitutor 1530 replaces the generated historical securities information with the new changed or altered original from the output of the analyzer 1510 and the output of the substitutor 1530 is provided as the output of the changer 1430.

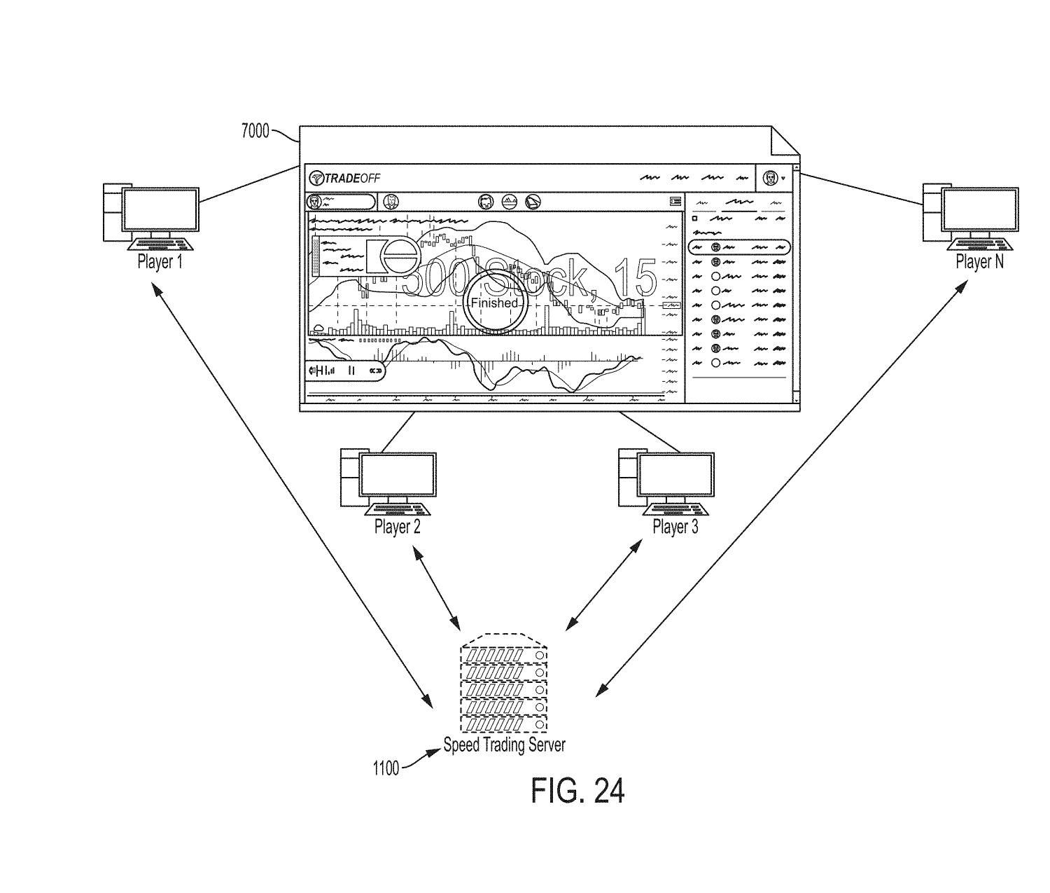

FIG. 24 shows an exemplary competition, in accordance with an implementation of the invention. Players 1 through N are shown to compete by trading securities, in this case stocks or stock series. They are each presented with a graph 7000, each viewing an accelerated modified historical data stream that they can use to generate each individual players' trades. The competition begins at a certain point in time, i.e. start of an event, and finishes at a certain point in time, a parameter that can be programmed. Graph 7000 shows the end of the competition. The players trade/compete through the server 1100. That is, the server 1100 master minds the competition from the start of the event until the event is finished. Each of the players, as shown in FIG. 24, compete using their respective client device, in this scenario shown as desktop computers. An additional embodiment could include other client devices like tablets or smart phones.

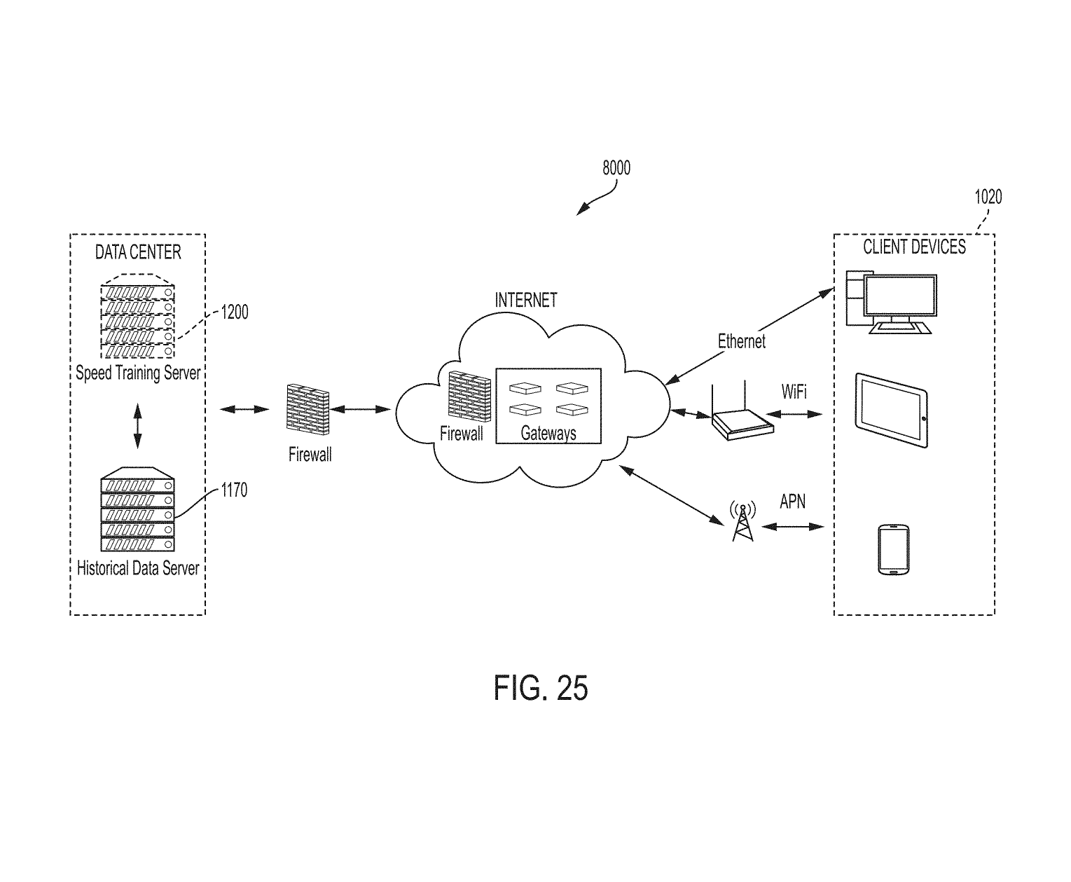

FIG. 25 shows a system 8000 employing an implementation of the disclosure. The client devices 1020 may be in the form of a desktop computer, an iPad, and/or smartphone. A data center may include the historical data server, such as the server 1200, and the trading server 1170, in FIG. 15. The data center, as typical data centers, may include additional servers and network equipment. The client devices 1020 may communicate in various ways, through the internet, to the data center. For example, wireless or wired communication may be employed. In the case of the former, a router may be employed to transfer information from one of the client devices 1020 to the internet and in the case of the latter, Ethernet may be employed. Still alternatively, APN may be employed where information from the client device travels through antennas to the internet.

The internet is shown to include gateways and one or more firewalls, as those typically employed by private or public clouds. Additional firewalls may be employed outside of the internet and before information is transmitted from the internet to the data center, for additional security.

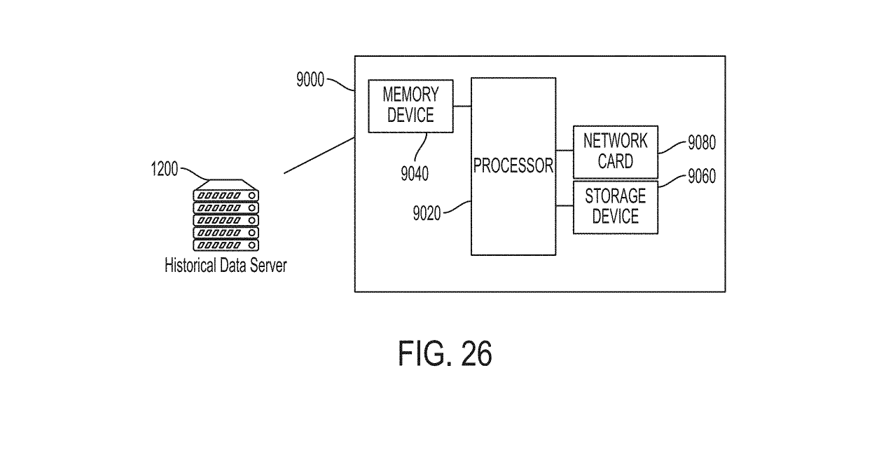

FIG. 26 shows further details of the historical data server 1200, in accordance with one of the implementations of the disclosure. The server 1200 is shown to include a system 9000, which is shown to include one or more processors 9020, a memory device 9040, network card 9080, and storage device 9060. The memory device 9040 is employed by the processor 9020 to store code and other information. The processor 9020, using the information stored in the memory device 9040, controls and directs the network card 9080 and the storage device 9060. The network card 9080 interfaces with the network to enable communication through the internet while the storage device 9060 is used to maintain large-sized data.

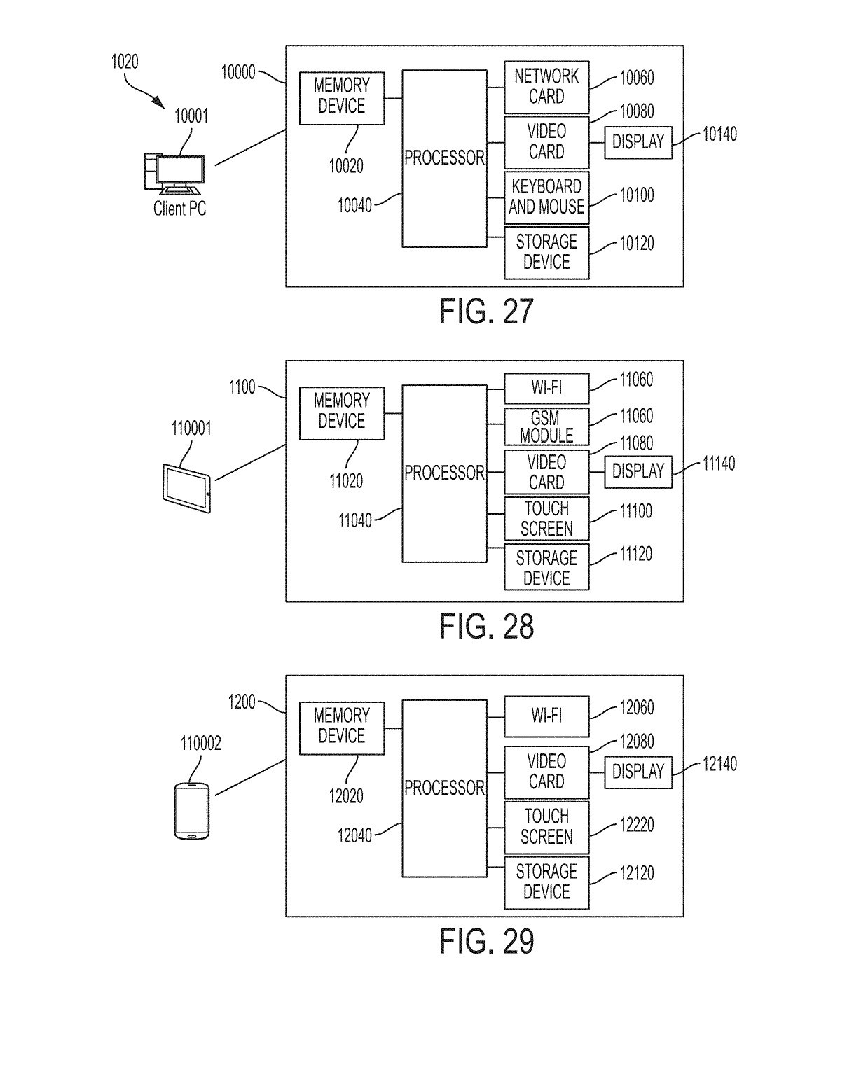

FIGS. 27-29 show details of various implementations of the client devices 1020. The client devices 1020 each communicate with data centers, through the internet, in various ways, as previously discussed, such as wirelessly. For instance, the iPad and smartphone each communicate wirelessly, with the smartphone using the global system for mobile communications (GSM) whereas the iPad does not. In the case of the desktop computer, the network card 10060 enables communication using the Ethernet. Each of the client devices 1020 is shown to include a system. For example, the desktop computer 10001, shown in FIG. 27, is shown to include the system 10000, the iPad 110001, in FIG. 28, is shown to include the system 11000 and the smartphone 120001, in FIG. 29, is shown to include the system 12000.

The system 10000 is shown to include a memory device 10020, a processor 10040, the network card 10060, video card 10080, keyboard and mouse 10100, storage device 10120, and the display 10140. The processor 10040 accesses its executable program in the memory device 10020 and upon execution thereof, the processor 10040 directs and controls the network card 10060, video card 10080, keyboard and mouse 10100, and storage device 10120. The video card 10080 controls the display 10140, which is shown to the player/competitor. The keyboard and mouse 10100 are employed by the player to input information into to the processor 10040 and the storage device 10120 saves large sizes of data and/or files for use by the processor 10040 and perhaps other components.

The systems 11000 and 12000 are each shown to include analogous components except that the systems 11000 and 12000 each also include WiFi 11060 and 12060, respectively, for wireless communication through the internet. Additionally, the systems 11000 and 12000 each employ touch screen and therefore each of the systems include a touch screen circuit 11100 and 12220 to accommodate touch screen features. In FIG. 29, the system 12000 additionally includes a GSM module 12200 for conforming the communication between the system 12000 and the mobile phone that is in communication with the system 12000, in accordance with the GSM protocol.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Some embodiments incorporate a method in a computing system for processing events in a competition from a rendered set of input signals representing initiation or participation in a competition and/or trading based on symbols with parameters captured from historical data in actual trading. In such embodiments, the system receives a sequence of one or more symbols captured from a rendered sequence of input by a user. The system identifies among the sequence a name with which an action has been associated. The system performs the associated action with respect to the user.

Some embodiments incorporate a system for spotting keywords input from a rendered sequence of names. In such environments, the system includes a hand-held mobile device or computer device usable by a user to capture a send one or more names of interest. The system further includes a processor that identifies among the sequence captured with the hand-held device and/or computer device a name with which an action has been associated, and that performs the associated action with respect to the user.

Some embodiments incorporate one or more computer memories storing data structures that map keywords to actions. In some embodiments, the data structure comprises, for each of a plurality of keywords that may be captured from rendered documents using a hand-held mobile device and/or computer device, an entry containing information specifying an action to be performed with respect to this keyword.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A trade emulating system comprising:
a simulated real-time trading engine including user graphics interface server coupled to the internet;
a speed trading events server configured to create a speed trading event and to send speed trading parameters to a history playback server, through a TCP/IP network connection, the history playback server being responsive to the speed trading parameters through a second TCP/IP network connection, wherein the speed trading parameters include historical period settings and playback speed settings; and
a historical data bank including a time-series server configured to access the time-series database storage device to retrieve the historical trading data, including market data, wherein the history playback server is configured to download the historical trading data through the internet according to the speed trading parameters and to adjust the market data according to the speed trading parameters,
wherein a speed trading event is initiated, after delivery of the downloaded historical data with up to a predetermined number of changes to speed trading data per second through the internet connection, the changed market data is displayed to users to allow analysis of market data to place orders, in real-time, until the speed trading event ends, the speed trading events server being configured to generate results of the speed trading event upon the end of the speed trading event.

2. The trading emulation system of claim 1, wherein the speed trading parameters include bars/minute, ticks streamed/price bar, ticks streamed/second, price bar aggregation, stock symbol, and start and end dates of data history.

3. A method for facilitating trading decision-making, the method comprising:
receiving a collection of price data relating to an investment from a data source in a processor;
processing said collection of price data related to an investment to generate a price chart related to the investment; and
generating at least one price chart derived from said processing step, whereas at least one price chart is generated at a faster accelerated streaming rate than the original price data history streaming rate for use with trading competitions.

4. The method of claim 1, further comprising the step of displaying said price chart on a display.

5. The method of claim 1, wherein the market symbol and accelerated rate of streaming price data is defined by an administrator, user, algorithm, or randomizer algorithm.

6. The method of claim 1, whereas the market symbol, absolute price values, and historical dates associated with the said collection or price data are manipulated or disguised to prevent users from recognizing the origination of said collection of price data for the purpose of preventing users from cheating.

7. The method of claim 1, wherein trading decisions from buy and sell trades generated by each user is processed to determine performance results for trading competition performance evaluation and ranking.

8. The method of claim 1, wherein the accelerated rate streaming price chart is used for trading competitions between multiple traders.

9. The method of claim 1, wherein the accelerated rate streaming price chart is used for trading competitions between multiple traders where each trader pays an entry fee in order to attempt to win a cash prize based on the performance of the trader in the trading competition.

10. The method of claim 1, wherein logic is used to determine what price data from said collection of price data will be utilized and what price data from said collection of price data will be removed when generating an accelerated streaming price chart.

11. The method of claim 4, wherein the said accelerated streaming price chart can include one or multiple trading indicators or chart drawing tools proximately to one another on a display.

12. The method of claim 4, wherein the data derived from said accelerated streaming price chart can be displayed in a tabular format, text format, or a graphical format.

13. The method of claim 8, further comprising a display of said price chart along with trading competition performance metrics proximately to one another on a display.

14. The method of claim 1, further comprising the step of displaying an accelerated streaming price chart for any user defined price bar aggregation time period or tick bar aggregation method.

15. The method of claim 8, further comprising a trading tournament where winning traders advance and where losing traders are removed from the tournament based on trading tournament parameters.

16. The method of claim 1, wherein the information is used by mathematical trading system to enter or exit an investment according to the criterion input into the mathematical trading system.

17. The method of claim 4, further comprising developing a plurality of accelerated streaming price chart displays of the same or different time frames.

18. The method of claim 4, further comprising developing a plurality of accelerated streaming price chart displays of the same or different market symbols.

19. A method for facilitating and making of trading decisions by a trader, and said method comprising the steps of:
receiving a collection of price data relating to an investment from a data source in a processor;
processing said collection or price data related to an investment to generate an accelerated streaming price chart related to the investment; and
generating trading competition results based on said streaming price chart and said trading decisions by each trader within a trading competition.

20. The method of claim 19, wherein traders are required to pay an entry fee to participate in said trading competition in order to compete to win a cash prize based on trading competition performance results.

21. The method of claim 15, further comprising a trading tournament including multiple trading competitions.

22. The system of claim 1, further including a merchant services system including a billing server responsive to the results of the speed trading event and configured to process enrollments of the users, wherein the trading emulation system using actual historical trading data emulates actual trading events by allowing users of the trading emulation system to utilize the historical trading data, in seconds, to trade with short trading times thereby avoiding lengthy actual trading events having substantially longer trading times.

23. A trading emulation system comprising:
a simulated real-time trading engine including a user graphics interface server coupled to the internet through a web interface;
a second server configured to send parameters to a third server through an internal TCP/IP network connection, the second server acting as an administrator and configured to initiate a speed trading event, the third server being responsive to the parameters through the TCP/IP network connection, wherein the parameters include historical period settings and settings of a playback speed;
a historical data bank including a time-series server configured to access the time-series database storage device to retrieve the historical trading data, wherein the history playback server is configured to download the historical trading data according to the speed trading parameters and to adjust market data, wherein users, through the web interface join the speed trading event and are delivered the downloaded historical data with up to a predetermined number of changes to speed trading data per second through the internet connection, displayed to the users to allow analysis of market data used by the users to place orders, in real-time, using the web interface until the speed trading event ends, the “speed trading events server” being configured to generate results of the speed trading event upon the end of the speed trading event;
a merchant services system including a billing server responsive to the results of the speed trading event and configured to process enrollments of the users, wherein the trading emulation system is configured to use actual historical trading data thereby emulating actual trading events by allowing users of the trading emulation system to utilize the historical trading data, in real time, to trade with short trading times thereby avoiding lengthy actual trading events having substantially longer trading times.
